(19) United States
(12) Patent Application Publication
(10) Pub. No.: US 2009/0092803 A1
(43) Pub. Date: Apr. 9, 2009

(54) SELF-ASSEMBLY TECHNIQUE APPLICABLE TO LARGE AREAS AND NANOFABRICATION

(75) Inventors: Ion Bita, San Jose, CA (US); Edwin L. Thomas, Natick, MA (US); Joel Kwang Wei Yang, Cambridge, MA (US); Yeon Sik Jung, Cambridge, MA (US); Caroline A. Ross, Arlington, MA (US); Karl K. Berggren, Arlington, MA (US)

Correspondence Address: WOLF GREENFIELD & SACKS, P.C., 600 ATLANTIC AVENUE, BOSTON, MA, 02210-2206, US

(73) Assignee: Massachusetts Institute of Technology, Cambridge, MA (US)

(21) Appl. No.: 12/239,362

(22) Filed: Sep. 26, 2008

Related U.S. Application Data
(60) Provisional application No. 60/995,505, filed on Sep. 27, 2007.

(51) Int. Cl. B32B 3/00; B44C 1/22

(52) U.S. Cl. 428/209; 428/195.1; 216/67

(57) ABSTRACT

The present invention provides articles and methods for affecting the self-assembly of materials. In some cases, the invention provides an approach for facilitating the self-assembly of various materials, including polymeric materials (e.g., block polymers), nanoparticles, other materials capable of self-assembly, and the like, over relatively large surface areas. Some embodiments of the invention provide articles (e.g., substrates) which, when contacted with a material capable of self-assembly, may produce greater control of self-assembly through the bulk of the material.

### RELATED APPLICATIONS

This application claims priority under 35 U.S.C. § 119(e) to co-pending U.S. Provisional Application Ser. No. 60/995,505, filed Sep. 27, 2007, the contents of which are incorporated herein by reference.

### STATEMENT REGARDING FEDERALLY SPONSORED RESEARCH OR DEVELOPMENT

This invention was made with the support under the following government contract: DMR-0213282 awarded by the National Science Foundation. The government has certain rights in the invention.

### FIELD OF THE INVENTION

The present invention generally relates to self-assembling materials, and related articles and methods.

### BACKGROUND OF THE INVENTION

Block polymers are macromolecules containing at least two chemically dissimilar polymer chains (e.g., blocks) covalently joined together as a single molecule. Block polymers having blocks that are chemically incompatible or immiscible, for example, at a particular temperature of interest may undergo phase separation. However, unlike oil-and-water systems where complete, macrophase separation typically occurs, the covalent bond joining the blocks together in a block polymer molecule may cause microphase separation, where the blocks may spontaneously segregate into nanoscale sized domains corresponding to each block, and where each of these domains may have a tendency to order in a periodic fashion throughout the microphase separated material. A variety of morphologies may be obtained from even a simple diblock polymer, and an even larger array of morphologies may be obtained with block polymers having additional block components, i.e., triblock terpolymers, which may have linear or star configurations, and the like. Block polymer morphologies, such as spherical and cylindrical morphologies in particular, may be useful for many nanolithography applications, as they may be used to produce two-dimensional nanostructures on given substrates. These patterns may then be used as masks for further processing steps, analogous to polymeric photoresist patterns produced by photolithography. For example, both cylindrical and spherical morphologies may lead to periodic arrays of circular features as presented to the top surface.

Often, the self-assembly of a block polymer on a flat substrate may lead to a polygranular morphology, wherein the polymer domains may be ordered locally (e.g., may form grains comprising a translationally periodic arrangement of said domains) but are disordered over long distances (e.g., uncorrelated orientation of individual grains). Thus, for various applications there may be a need to increase the size of the ordered grains to resemble a single crystal morphology, and to reduce the concentration of point defects occurring in the ordered grains. As a result, the self-assembled material may produce nanostructures with predetermined orientations and with predetermined locations of individual domains across very large areas.

There are currently two main ways to guide the self-assembly of block polymers into thin films on flat substrates. One approach employs topography on the substrates to confine the block polymer domains. Another approach may involve the creation of a surface energy pattern (e.g., comprising hydrophobic and hydrophilic domains) such that the block polymers domains wet preferentially different parts of the surface (e.g., a polar cylinder-forming block may preferentially locate on top of, for example, a hydrophilic patch, while a non-polar matrix block wets the hydrophobic surrounding surface area). This approach may be limited to a few types of morphologies (e.g., not spheres, since only the matrix block may be found typically at the film-substrate interface).

Typically, topography has been used to confine block polymer spheres or cylinders in gaps with precise width. However, as currently implemented, there are fundamental problems with this approach. First, the larger the gap, the smaller the confinement effect and the higher the concentration of defects. One additional problem that may exist using this method may stem from the need to cover a desired substrate with “walls” to define gaps that are packed closely enough. Thus, much of the active device area may be lost to these walls and furthermore a great limitation on the resulting patterns may be imposed by the need to have straight walls. Another problem may stem from the fact that the confining walls essentially allow for one-dimensional control only. Since the block polymer structure is two-dimensionally periodic, its formation and orientation cannot be uniquely determined by the one-dimensional perturbation represented by the walls, such that separate grains are typically formed along the channel due to the loss of correlation between multiple ordered regions contacting the walls. Even smaller gaps may not allow perfect control over the orientation, as the smaller the gap, the longer the correlation distance along the channel. Furthermore, in this approach there is no correlation between ordered grains from one channel and the ordered grains found in adjacent channels on the same substrate. The use of non-parallel walls, such as wedges or enclosed perimeters of various geometrical shapes, is also known to allow guiding the self-assembly of block polymers, but is subject to some of the same problems of the parallel walls case, such as loosing a significant portion of the device area to walls, and absence of cross-talk between ordered grains across a given wall.

Accordingly, improved methods are needed.

### SUMMARY OF THE INVENTION

The present invention relates to articles comprising a substrate comprising a plurality of guiding features arranged periodically in two dimensions on or in a surface of the substrate; and a material capable of forming a periodic structure on the substrate, the periodic structure comprising at least one periodically occurring domain, wherein the periodicity of the guiding features is at least X times greater than the periodicity of the domains of the periodic structure, wherein X is greater than 1.0.

The present invention also provides methods of forming a patterned substrate comprising providing a base material; effecting differential reaction, within the base material, to define a patterned substrate precursor, the precursor comprising a plurality of features solidified relative to material surrounding the features; removing base material adjacent the patterned substrate precursor; and treating the substrate precursor to reduce the size of the features, such that the features have at least one dimension that is 100 nm or less, thereby forming a patterned substrate.

### BRIEF DESCRIPTION OF THE DRAWINGS

FIG. 1 illustrates some examples of morphologies of microphase-separated diblock polymers as a function of polymer composition.

FIGS. 2A-B show illustrative embodiments of posts positioned on a substrate for use as guiding features to facilitate self-assembly of spherical morphology materials.

FIG. 3 shows a Scanning Electron Microscope (SEM) image of a thin film of self-assembled block polymer having spherical morphology that is disordered over a long distance, showing grain boundaries with dashed lines, and point defects with pentagons.

FIGS. 4A-C illustrate a triangular lattices of posts (post locations are marked by large, dark circles) that are commensurate with and may be used to template a triangular lattice of self-assembling material (e.g., domains locations are marked by smaller circles), i.e., where the ratio of guiding feature periodicity to material periodicity is an integer.

FIG. 5A shows the relationship of post diameter to periodicity and domain size of a block polymer having spherical morphology, with stars indicating regions where defects may be formed.

FIG. 5B shows illustrative embodiments of guiding features having various sizes and shapes.

FIG. 6 shows various steps in the fabrication of a substrate of the invention.

FIG. 7 illustrates, schematically, fabrication of a polymer mask pattern from a self-assembled block polymer pattern, wherein both spherical and cylindrical morphologies are used to produce a two-dimensional periodic structure (e.g., a triangular lattice) by removal of one domain of the periodic structure.

FIG. 8 shows an SEM image of a block polymer assembled on a template according to one embodiment.

FIG. 9A shows top-down (top) and side-view (bottom) schematic representations of PS-b-PDMS block copolymer molecules in the region surrounding a single post.

FIG. 9B shows a scanning-electron micrograph (SEM) image of a disordered monolayer of BCP spherical domains, with an the inset showing a two-dimensional (2D) Fourier transform of the domain positions.

FIG. 9C shows an SEM image of ordered block copolymer spheres formed within a sparse 2D lattice of HSQ posts (brighter dots) functionalized with a PDMS brush layer, with the inset showing the 2D Fourier transform of the domain positions.

FIG. 9D shows an SEM image of ordered block copolymer spheres formed within a sparse 2D lattice of HSQ posts (brighter dots) functionalized with a PS brush layer, with the inset showing the 2D Fourier transform of the domain positions.

FIG. 10 shows (a) a graph of the calculated orientations at which the BCP microdomain lattice is commensurate with the post lattice, as a function of Lₚₒₛₜ/Lₒ (Lₒ is the equilibrium period of the BCP microdomain lattice), and plan-view SEM images of orientations observed within the range Lₚₒₛₜ/L=1.65 to 4.6, for (b) a <11> orientation where θ=30°, (c) a <22> orientation where θ=30°, (d) a <32> orientation where θ=23.4°, (e) a <21> orientation where θ=19.1°, (f) a <31> orientation where θ=13.9°, (g) a <41> orientation where θ=10.9°, (h) a <20> orientation where θ=0°, (i) a <30> orientation where θ=0°, and (j) a <40> orientation where θ=0°, for the Lₚₒₛₜ/L₀ ratio range of 1.65 to 4.6.

FIG. 11 shows (a) a graph of the calculated curves of free energy per BCP chain vs Lₚₒₛₜ/L₀ for each commensurate configuration and (b) a graph of the area fraction of each <ij> lattice is shown as a function of Lₚₒₛₜ/L₀.

FIG. 12A shows an SEM image showing two degenerate <21> BCP microdomain lattice orientations (i.e. +19.1° and −19.1°) forming on one post lattice.

FIG. 12B shows an SEM image of a unique BCP microdomain lattice orientation obtained by breaking the periodicity of the post template with an aperiodic sparse arrangement of posts positioned at randomly chosen lattice points on the BCP lattice.

FIG. 12C shows an SEM image of a motif including pairs of posts.

FIG. 12D show a plot of area fraction versus Lₚₒₛₜ/L₀ for two template designs, single-post and double-post lattices.

FIG. 12E shows an SEM image of a BCP <30> array guided by pillars having a 15 nm diameter, but with equal center to center spacing of 120 nm.

FIG. 12F shows an SEM image of a BCP <30> array guided by pillars having a 25 nm diameter, also with equal center to center spacing of 120 nm.

FIG. 12G shows an SEM image of a well-ordered BCP <30> array guided by pillars having a cross-section in the shape of 45-nm×25-nm ellipses, with equal center to center spacing of 120 nm.

FIG. 13 shows various steps in a procedure for SEM image analysis, including (a) an SEM image of a BCP template, (b) an SEM image of the BCP template with the center for each post identified as a dot, and (c) a Voroni diagram of the BCP template.

FIG. 14 shows a schematic representation of a tri-layer photoresist stack, according to one embodiment of the invention.

FIG. 15 shows a schematic representation of various stages in the fabrication of a substrate, including SEM images of the various stages.

FIG. 16A shows the tri-layer resist stack structure including (i) a photoresist, (ii) a SiO2 interlayer, (iii) an anti-reflection coating, and (iv) a thermal oxide coating, and (v) a silicon substrate.

FIG. 16B shows a graph of the reflectivity as a function of ARC layer thickness, in the case of a 300 nm period grating, wherein the simulations use the refractive index data shown in Table 3.

FIG. 17 shows (a) a schematic representation of various stages in the fabrication of a substrate, (b) SEM images of substrates after a one-stage reduction in post size, and (c) SEM images of substrates after a two-stage reduction in post size.

Other aspects, embodiments and features of the invention will become apparent from the following detailed description when considered in conjunction with the accompanying drawings. The accompanying figures are schematic and are not intended to be drawn to scale. For purposes of clarity, not every component is labeled in every figure, nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### DETAILED DESCRIPTION

The present invention generally relates to articles and methods for affecting the self-assembly of materials. The invention provides an approach for facilitating the self-assembly of various materials, including polymeric materials (e.g., block polymers), nanoparticles, liquid crystals, other materials capable of self-assembly, and the like, over relatively large surface areas. Some embodiments of the invention provide articles (e.g., substrates, molds) which, when contacted with a material capable of self-assembly, may produce greater control of self-assembly through the bulk of the material. For example, block polymers may be assembled in thin films over ultra-large area substrates, i.e., silicon wafer scale, using articles and methods of the invention.

One advantageous feature of the invention is that the periodic structure may be at least partially oriented using articles and methods of the invention. In some embodiments, a two-dimensional array of topographical features may be placed in contact with a material to facilitate and/or improve formation of a two-dimensional periodic structure throughout the bulk of the material. For example, the present invention may involve the use of an array of guiding features that form a two-dimensional periodic lattice, wherein the periodic lattice is commensurate with the lattice of a self-assembling material (e.g., a block polymer lattice). As used herein, the term “commensurate with” means that the periodicity of the lattice of guiding features is an integer multiple of the periodicity of the lattice of the self-assembling material. In an illustrative embodiment, the use of a lattice of posts having a periodicity (e.g., Lₚₒₛₜ) that is commensurate with that of the block polymer may enable large area patterning of a single block polymer grain.

In some cases, the material may be ordered on a macroscopic scale (e.g., crystalline), as well as microscopic scale (e.g., grains). While previous methods may be used to achieve order on a microscopic scale (e.g., grains), the material may be disordered on the macroscopic scale, i.e. such as a polycrystal. For example, FIG. 3 shows an SEM image of a nanostructured thin film produced by a self-assembled block polymer having spherical morphology, showing that the nanostructure is disordered over a long distance. Pentagons are used to indicate five-fold coordinated spheres (e.g., point defects) and dotted lines are used to show grain boundaries. Articles and methods of the invention may advantageously provide order on both macroscopic and microscopic scale, over a large surface area.

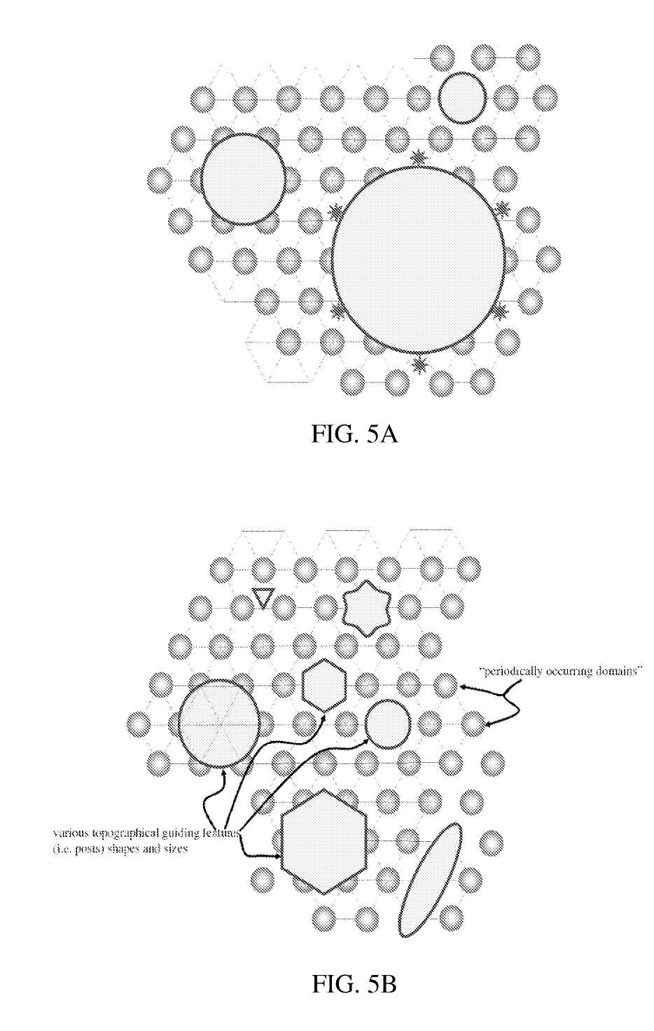

The size, shape, spacing, and other characteristics of the guiding features of the article may be selected such that the material (e.g., block polymer, nanoparticles, liquid crystals), when placed in contact with the article, may be at least partially oriented by the guiding features. In some embodiments, the guiding features may orient the material by affecting the location and/or orientation of at least a portion (e.g., domain) of the material. For example, FIG. 5A shows the relationship of post diameter to periodicity and domain size of a block polymer having spherical morphology, with stars indicating regions where defects may be formed. In some cases, the guiding features may contact a first portion of the material such that the portion of the material becomes ordered in a particular orientation. By symmetry, other portions of the material may become ordered to have the same orientation as the first portion, such that the bulk of the material may have macroscopic order. For example, a portion of the material positioned within a triangular area formed by three guiding features may become ordered, and, by symmetry, other regions of the material may be ordered with the same orientation with regard to the guiding features. That is, the guiding features may allow for a single possible global orientation of the bulk material, where the triangular lattice of the material adopts a unique orientation within the triangular lattice of the guiding features. Alternative orientations of the material may be energetically unfavorable, as structural defects would be introduced in the vicinity of locations where perfect ordering would require some of the domains of the material to overlap with incompatible guiding features (e.g. a sphere-forming domain overlapping with a post, a cylinder-forming polar domain overlapping with a non-polar guiding feature, etc.). In this way, the article may affect and/or improve self-assembly of materials. In some cases, a material may self-assemble to form a periodic lattice comprising one or more domains, wherein at least one domain may be positioned within a triangular area formed by three guiding features.

In some cases, articles and methods of the present invention may provide greater control of the orientation of an ordered, block polymer structure on a substrate. The formation of various block polymer morphologies may be facilitated by contacting the block polymer with an array of guiding features as described herein, wherein the periodicity of the guiding features is commensurate with the periodicity of the block polymer. Methods of the invention may advantageously aid in the two-dimensional assembly of the block polymer, providing guiding features positioned throughout the bulk of the material to facilitate formation of various morphologies, over relatively large surface areas. The present invention may also enable a host of possible practical applications that rely on ordered block polymer structures, such as in block polymer nanolithography, where polymer patterns may be used as masks for various semiconductor processing steps (e.g., etching, deposition, implantation, etc.).

In some cases, the present invention provides articles comprising a substrate comprising a plurality of guiding features arranged periodically in two dimensions on or in a surface of the substrate. The article may also comprise a material capable of forming a periodic structure on the substrate, wherein the periodic structure comprises at least one periodically occurring domain. The guiding features may be arranged such that the distance between each guiding feature and a nearest, adjacent guiding feature is greater than a dimension of the domain. For example, the guiding features may have a periodicity that is a multiple of and is commensurate with the periodicity of the material (e.g., polymer, nanoparticles). That is, the periodicity of the guiding features may be at least X times greater than the periodicity of the domains of the periodic structure, wherein X is greater than 1.0, greater than 2.0, greater than 5.0, greater than 10, greater than 25, greater than 50, greater than 75, or, in some cases, greater than 100. However, in some embodiments, X may have an intermediate value between two integers (e.g., X.1, X.2, X.3, X.4, X.5, X.6, X.7, X.8, or X.9).

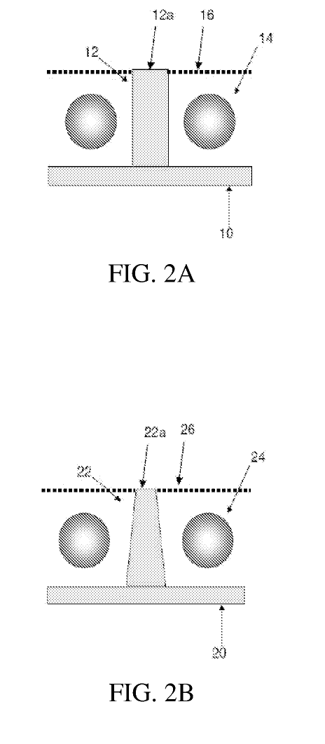

In some cases, the guiding features may be arranged on or in a surface of a substrate to form a periodic lattice. In some cases, the guiding features may be arranged on the surface a substrate to form both a periodic superlattice and a periodic sublattice positioned within the superlattice, as described more fully below. In some cases, the guiding features may be posts arranged on or in the surface of a substrate. As shown in FIG. 2A, guiding feature 12 may be positioned on substrate 10, such that a material capable of forming a periodic lattice having domains 14 and a top surface 16 may be at least partially ordered by the guiding feature. The length, width, height, diameter, cross-sectional shape, or other characteristic of the posts may be selected to suit a particular application. In some embodiments, at least a portion of the guiding feature may have a cross-sectional shape with a rotational symmetry that may match a local rotational symmetry of the templated material. For example, posts with a 6-fold rotationally symmetric cross-section (e.g., substantially hexagonal) can be used to template a triangular lattice self-assembling material, such as a diblock polymer. In some cases, the guiding features are arranged periodically in two dimensions on a triangular lattice, or, in two dimensions on a rectangular lattice that may be commensurate with a triangular lattice of the periodic structure.

In some embodiments, the guiding features are posts having a cross-section with a rotational symmetry equal to a local rotational symmetry of the periodic structure. For example, in triangular lattice self-assembling materials, advantageous guiding feature cross-sections include triangular and hexagonal shapes due to the compatibility of these shapes with the rotational symmetries of 3 sphere clusters, and of 6 sphere clusters, as shown in FIG. 5B. In some embodiments, the rotational symmetry of the cross-section of at least one portion of the guiding feature exceeds a local rotational symmetry of the templated material. For example, posts with a circular cross-section can be used to template a triangular lattice self-assembling material. In some embodiments, the rotational symmetry of the cross-section of at least a portion of the guiding feature is selected so that the guiding feature coordinates around itself a desired number of domains in the self-assembled material. For example, posts with 3-fold rotational symmetric cross-sections (e.g., substantially triangular) can be used to template clusters of 3 domains belonging to a triangular lattice self-assembled material.

In some cases, at least a portion of the guiding feature may have a cross-sectional shape that is substantially circular, oval, square, rectangular, pentagonal, triangular or hexagonal. In some embodiments, the guiding features are cylindrical posts. In some embodiments, a first portion of an individual guiding feature can have a cross-sectional dimension that is less than the cross-sectional dimension of a second portion of the guiding feature. For example, the guiding feature may have non-parallel sidewalls, as shown by post 22 positioned on substrate 20 in FIG. 2B, to form a trapezoidal shape. Post 22 may aid in the ordering of a material having domains 24 and a top surface 26.

In some embodiments, the height of the guiding posts is selected as to be equal to or slightly larger than the thickness of the self-assembling material. In some embodiments where a spherical morphology block polymer is guided, the post height may be larger than or equal to the minimum thickness of the block polymer film where a sphere monolayer is self-assembled. In some embodiments, where the self-assembly in a thin film of a block polymer may have a two dimensionally periodic morphology in the bulk state (e.g. cylindrical morphology), the post height may be larger than or equal to the block polymer film thickness. That is, the guiding features may comprise a topography with an average height comparable to the thickness of the self-assembling material. For example, the material shown in FIG. 2A may have thickness such that top surface 16 is located at substantially the same height as top surface 12a of post 12. Similarly, the material shown in FIG. 2B may have thickness such that top surface 26 is located at substantially the same height as top surface 26a of post 22. In some cases, the top surface of the material may be located at a position that is less than or greater than the height of the top surface of one or more of the guiding features.

In some embodiments, fabrication of the guiding features (e.g., posts) may include electron beam patterning of hydrogen silsequioxane (HSQ) resist films, where regions exposed to an electron beam are crosslinked and, upon developing, form topographical guides with heights comparable to the initial HSQ film thicknesses. Other electron beam resists and/or additional processing steps may be used to create the guiding features (e.g. etching into a substrate with a mask defined by e-beam writing into the resist). In some cases, the cross-sectional shape of the resulting posts can be controlled by multiple exposures of the resist by the electron beam. For example, a 3-fold rotationally symmetric cross-section can be obtained by e-beam writing three overlapping circular dots, appropriately displaced towards the vertices of an equilateral triangle. FIG. 5B shows other illustrative embodiments of guiding features having various sizes and shapes.

In some cases, the guiding features may be arranged on or in the surface of the substrate to form a pattern of features having different properties, such as surface energy features. That is, at least a portion of the guiding features are arranged on or in the surface of the substrate as a pattern of features having different surface energy properties relative to other portions of the substrate. For example, the guiding features or portions thereof may exhibit different wetting properties relative to the rest of the substrate and may be arranged to form a pattern on the surface of the substrate. In some embodiments, at least a portion of an individual guiding feature may comprise a surface coating which can enhance or improve the wetting ability of at least one, but not of all, of the domains of the material exposed to the surface of the particular guiding feature. As used herein, the term “wetting” is given its ordinary meaning in the art and refers to the interaction between a fluid and a surface when the fluid and surface are brought into contact with one another. The degree of wetting, in some cases, may be measured by the surface tension of the fluid, the surface energy of the surface, and/or the compatibility or miscibility of the fluid and the surface.

In some cases, the pattern may be capable of forming, stabilizing, or otherwise facilitating formation of a periodic structure when contacted with a material. The substrate surface may comprise a pattern of hydrophobic patches, with the rest of the substrate surface being hydrophilic, such that contacting the substrate with a material may facilitate formation of hydrophobic domains on the hydrophobic patches and hydrophilic domains on the hydrophilic patches. In an illustrative embodiment, a substrate surface may comprise a pattern of circular patches of hydrophobic surface coatings, with the rest of the substrate surface being hydrophilic, such that contacting the substrate with a block polymer may facilitate formation of hydrophobic domains on the circular patches and hydrophilic domains on the hydrophilic surface area. In some cases, the pattern of surface features may be used to assemble spherical or cylindrical morphologies. Those of ordinary skill in the art would be able to select materials that may be useful as hydrophilic or hydrophobic domains, as described herein. For example, a hydrophilic domain may comprise materials comprising hydroxyl group, poly(ethylene glycol) groups, amine groups, and the like, while a hydrophobic domain may comprise alkyl groups, aryl groups, and the like.

In some cases, the guiding features may comprise a magnetic material. For example, a substrate may comprise an array of posts comprising a magnetic material such that, upon contact of the substrate with a material, a magnetic field may be applied to the posts and the material may be at least partially ordered by the magnetic field.

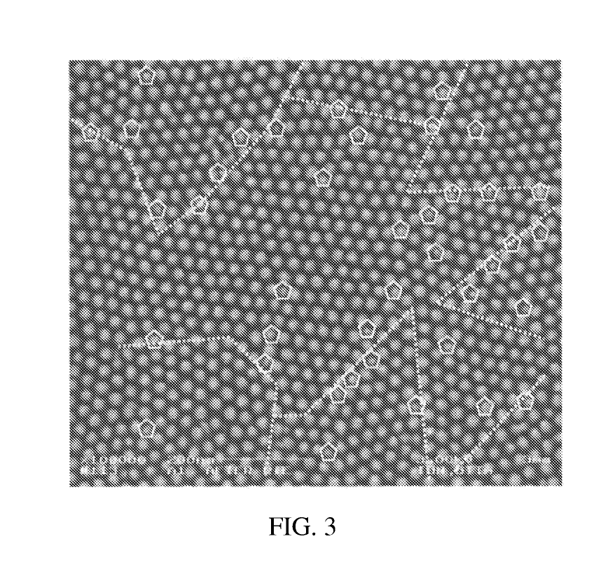

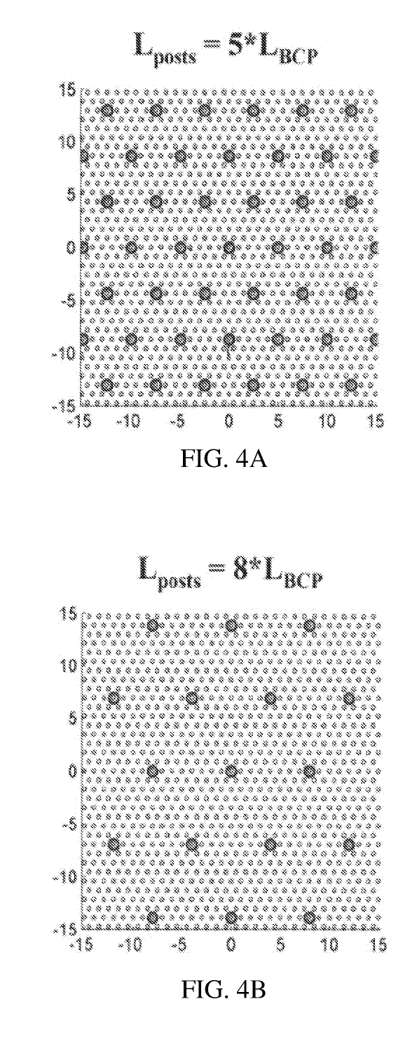

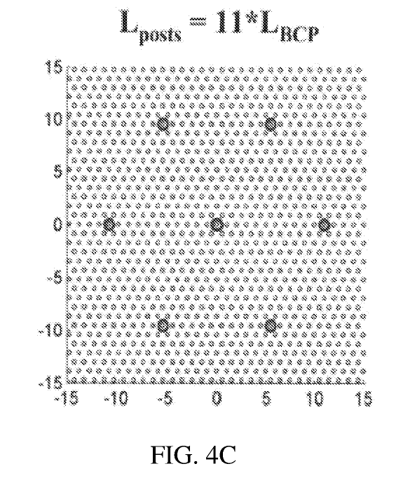

As described herein, the periodic arrangement of the guiding features may be commensurate with the periodic arrangement of the self-assembling material. In some cases, the guiding features have a lattice geometry that is the same as the lattice geometry of the material. For example, as shown in FIGS. 4A-C, a triangular lattice of posts (e.g., posts shown as large, dark circles) may be used to template a triangular lattice of self-assembling material (e.g., domains shown as smaller circles), i.e., the ratio of guiding feature periodicity to material periodicity is an integer. In some cases, the guiding features have a lattice geometry that is different from the lattice geometry of the material. For example, a rectangular lattice of guiding features may be used to aid in formation of (e.g., template) a triangular lattice of material, wherein, if A is the periodicity of the triangular lattice, then the periodicity of the rectangular lattice is a multiple of λ/2 for the short dimension and a multiple of sqrt(3)*A/2 for the long dimension.

Some embodiments may include the periodic arrangement of guiding features wherein the arrangement comprises a combination of two or more lattices. For example, the guiding features may be arranged such that a “superlattice” of guiding features and a “sublattice” of guiding features positioned within the superlattice are formed. In some cases, the sublattice may advantageously interrupt or “break” the periodicity of the superlattice. For example, removal of one or more guiding features, or incorporation of guiding features having different properties relative to those of the superlattice, may “break” the periodicity of the superlattice. In some cases, the sublattice may have a periodicity commensurate with the periodicity of the guiding features and/or material in contact with the guiding features. In some cases, the sublattice may have a different periodicity than the periodicity of the guiding features and/or material in contact with the guiding features. In some cases, the sublattice may include randomly-arranged features that break the preiodicity of the superlattice. Inclusion of a sublattice may improve the alignment and/or orientation of the material in contact with the guiding features.

In some cases, the sublattice may comprise guiding features (e.g., posts) having the same features and characteristics as the guiding features of the superlattice. In some cases, the sublattice may comprise guiding features (e.g., posts) having different features and characteristics as the guiding features of the superlattice. That is, some embodiments may comprise a superlattice comprising a first set of guiding features and a sublattice comprising a second set of guiding features, wherein the first and second sets are different. In some cases, the sublattice may include posts, pairs of posts, or, in some cases, sites which do not comprises posts. In one set of embodiments, the superlattice comprises a set of guiding features comprising posts and the sublattice comprises a set of guiding features which does not comprise posts.

In an illustrative embodiment, when a superlattice is not commensurate with the material (e.g., BCP) along a particular low index direction (e.g., <10>), then the material, or portion (e.g., domain) thereof, may adopt alternative, substantially energy-equivalent orientations that are approximately commensurate (e.g., <41>). This may result in formation of undesired orientations or grains within the material. Therefore, “seeding” of a specific orientation (e.g., <41> and not <14>) via inclusion of a sublattice can provide monogram, single crystal, long range order within the material.

Articles of the invention may facilitate orientation and/or self-assembly of materials, with the guiding features effectively functioning as walls between which the material organizes. The separation between adjacent posts and/or the choice of the post diameter may allow for a control comparable to the separations between walls that lead to ordering in the direction perpendicular to the walls. In some cases, the ideal post size is comparable or smaller than a block polymer microdomain. The exact value may be determined by taking into account the thickness of the polymer brush layer that may be formed on the surface of the posts upon adsorption of block polymer molecules. In some embodiments, the surface energy of the guiding features can also be tailored for increasing selectivity of affinity towards one of the block polymer domains. For example, the surface of cylindrical post templates can be functionalized with a homopolymer brush chemically similar to the majority block of a templated, self-assembled spherical morphology block polymer in order for the required optimum post diameter to be somewhat larger, and easier to fabricate.

The present invention also provides methods for orienting a material. The method may comprise contacting a patterned substrate with a material capable of forming a periodic structure on the patterned substrate, wherein the periodic structure comprises at least one periodically occurring domain. The material may comprise block polymers, nanoparticles, liquid crystals, or other materials capable of forming a periodic structure. Those of ordinary skill in the art will be able to select, based upon the teaching of this disclosure, suitable material capable of forming such a periodic structure. In addition, simple screening techniques can be used to identify those materials capable of forming a periodic structure in accordance with the invention from those that may not be capable. Screening tests for selection of suitable polymer materials are described elsewhere in this disclosure. Screening tests for selection of other materials can include, for example, placing the material in a confined space and determining whether at least certain portions of the material self-assemble into a periodic arrangement suitable for use in the present invention. Determining techniques can include X-ray diffraction, electron microscopy, and other techniques well-known to those of ordinary skill in the art. By “confined space” is meant a space having a wall, walls or other boundaries or guiding features, including confinement in a thin film between the substrate and a superstrate, that cause at least some portion of the material to self-assemble or organize in a manner allowing this determination. In some cases, a material will be confined to an area or guided by a guiding feature, such that some of the material self-organizes or self-assembles in a manner indicating suitability for use in the present invention, but other portions might not. Those of ordinary skill in the art will recognize that, in a case such as this, the material may be suitable for self-assembly or organization to a larger extent based upon a confining space for other guiding features sized or otherwise arranged to promote self-assembly throughout a larger portion, or all of the material.

In some cases, the method further comprises treating the periodic structure to remove the first periodically occurring domain or the second domain. For example, a block polymer may comprise one or more domains (e.g., blocks of polymethyl-methacrylate, polyferrocenylsilane, polydimethylsiloxane) which can be selectively removed or chemically transformed within the periodic structure. The domain(s) may be removed or transformed by exposure to a chemical species, electromagnetic radiation, or other external source of energy. For example, at least one domain within the periodic structure can be comprised of a species (e.g., a polymeric species) which can be degraded and subsequently removed from the structure to form a porous structure. For example, FIG. 7 illustrates, schematically, fabrication of a polymer mask pattern from a self-assembled block polymer pattern, wherein both spherical and cylindrical morphologies are used to produce a two-dimensional periodic structure (e.g., a triangular lattice) by removal of one domain of the periodic structure.

In some cases, the periodic structure may be treated to remove at least one domain (e.g., a periodically occurring domain), such that another domain remains and is not removed by the treatment. In some cases, the remaining domain may be useful as a mask for further processing steps, including deposition, etching, implantation, or irradiation with light, electron-beams, or other sources of radiation.

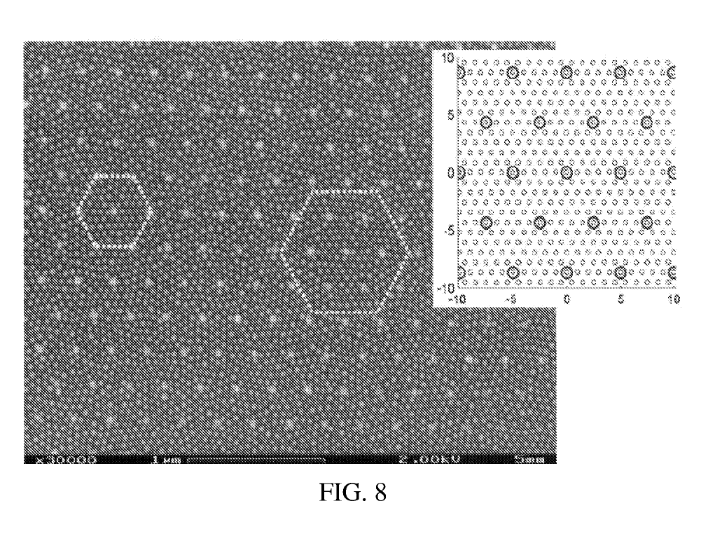

In an illustrative embodiment, a polystrene-poly(methylmethacrylate) block polymer may form a periodic structure having a cylindrical morphology, wherein cylinders comprising poly(methylmethacrylate) are surrounded by a polystyrene matrix. The periodically occurring cylinder domain can be selectively removed (e.g., by ozone treatment) or the matrix around the periodically occurring domain be removed. In another embodiment, a periodic structure comprising a polystyrene-polyferrocenylsilane block polymer, oxidation may be used to remove the polystyrene matrix, leaving behind inorganic nanoparticle-like islands comprised of mixed iron-silicon-oxygen compounds. FIG. 8 shows an SEM image of a block polymer that is assembled on a template comprising a two-dimensional triangular lattice array of posts, according to one embodiment. As shown in FIG. 8, the posts may template 7 or more spheres around each posts. This illustrates that an array of guiding features having the same symmetry as a self-assembling material may be used to affect orientation of the domains of the material.

Periodically-ordered materials fabricated using methods of the invention may be useful for various applications. For example, methods of the invention may be useful in forming a single layer of nanoparticles (e.g., metal nanoparticles) for plasmonic applications. Structures having two- or three-dimensional periodicity may be useful in, for example, biosensing applications, photonics, phononics, and the like.

Another aspect of the invention provides methods for making substrates having an array of guiding features as described herein. In some cases, the substrate comprises features with sizes in the sub-100 nanometer range, with uniform control over post shape, size and spacing over ultra-large areas. In some cases, the method may involve the use of lithography including interference lithography. Interference lithography may allow for control of the periodicity of the structure by selecting the wavelength of light (e.g., using a laser) to generate the interference pattern. In some cases, an entire 300 mm (12 inch) wafer may be patterned uniformly.

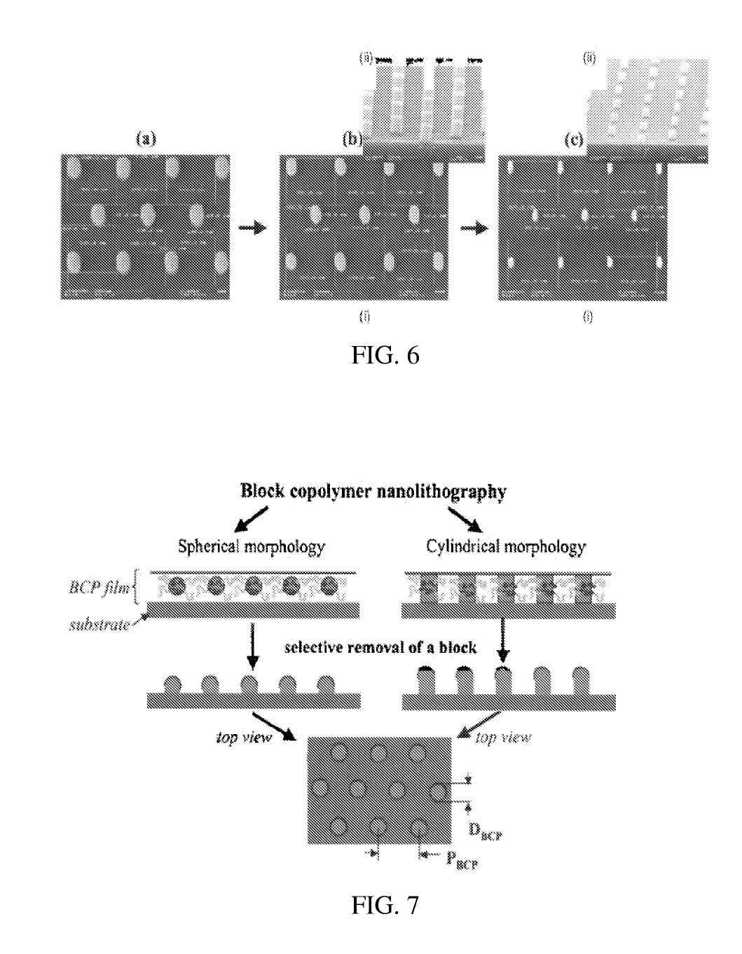

In some cases, the fabrication process may involve patterning large areas with interference lithography, optionally followed by uniformly shrinking the size of the resulting features down to the typically required sub-50 nanometer size region. In some cases, the size reduction step may be performed using reactive ion etching (e.g., exposure to O₂ plasma). Those of ordinary skill in the art may be able to select the calibration of the etching rates and corresponding process parameters. FIG. 6 shows the various steps in the fabrication of a substrate of the invention, including (a) the initial photoresist pattern, (b) a shrunken photoresist transferred to an anti-reflection coating layer, and (c) shrunken anti-reflection layer posts. Steps (1) and (2) were performed using reactive ion etching.

Methods of the invention may utilize holographic interference lithography (HIL), a process which involves the formation of a time independent spatial variation of intensity created by the interference of two or more sources of external energy, to pattern the desired structure within a bulk sample of photoresist. That is, a sample material may be exposed to at least two sources of external energy to produce a geometrical structure within the bulk of the sample material at the location(s) where the at least two sources of external energy meet or interfere. The pattern that emerges out of the intensity distribution may be transferred to a light sensitive medium, such as a photoresist, to yield structures. By selecting the appropriate the parameters for the sources of external energy, the geometrical elements and volume fraction of the resulting structures may be controlled. For example, manipulation of the experimental parameters of intensity, polarization, phase and wave vectors of the interfering sources may allow one to target specific structures.

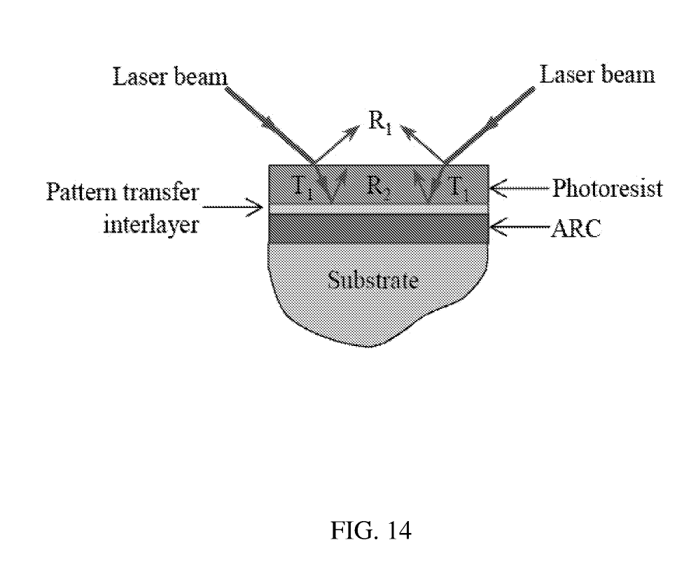

Some embodiments of the invention utilize a substrate comprising one or more materials that may facilitate the formation of guiding features on the substrate. For example, the substrate may comprise at least one coating, such as a thermal oxide material (e.g., SiO₂), formed on the substrate. Other materials may be formed on the substrate, prior to formation of various guiding features. In one set of embodiments, a “tri-layer” resist stack comprising a photoresist, a pattern transfer interlayer, and an anti-reflection coating may be formed on a substrate. (FIG. 14) The optically absorbing anti-reflection coating may be used to substantially reduce or eliminate the reflection R₂ from the bottom of the photoresist layer, such that only the interference between the T₁ rays is recorded. An optically thin interlayer (e.g., 20 nm) may be positioned between the anti-reflection coating and the photoresist layers in order to improve the accuracy with which the photoresist pattern is captured.

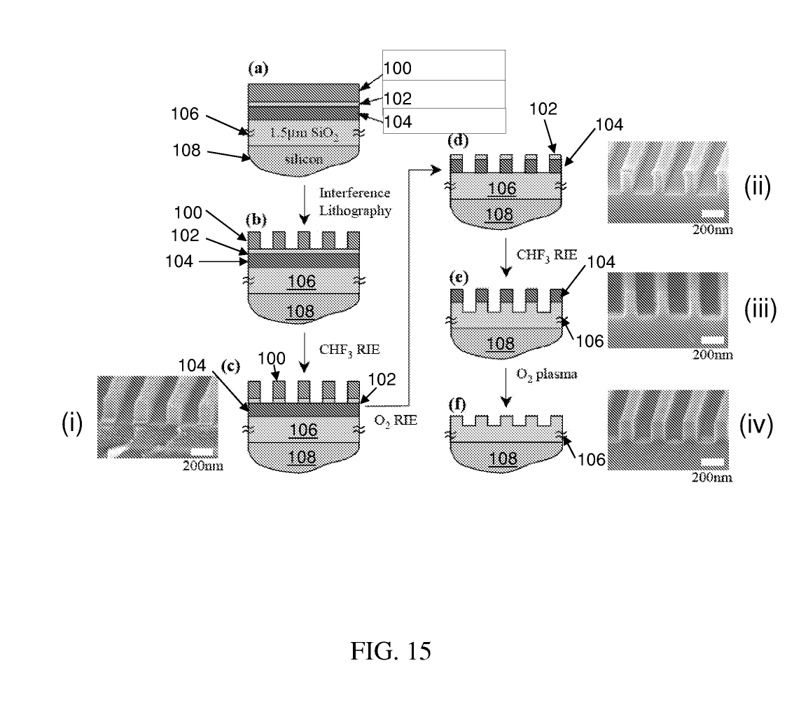

In an illustrative embodiment, FIG. 15 shows a schematic representation of various stages in the fabrication of a substrate. As shown in FIG. 15A, various layers may be formed on substrate 108 coated with thermal oxide 106, including photoresist 100, interlayer 102, and anti-reflection coating 104. Lithography may be used to pattern photoresist 100, as shown in FIG. 15B. Dry etching may then be used to “project” the photoresist structure into interlayer 102, for example, using reactive ion etching with CHF₃ or CF₄ gases, as shown in FIG. 15C. The resulting structure may then transferred into anti-reflection coating 104 by etching via O₂ reaction etching, using the patterned interlayer 102 as a mask, as shown in FIG. 15D. FIG. 15E shows transfer of the pattern to the thermal oxide coating 106 via etching, using anti-reflection coating 104 as a mask. Finally, as shown in FIG. 15F, the final substrate may be obtained by removal of anti-reflection coating 104 via treatment with oxygen plasma, piranha, or the like.

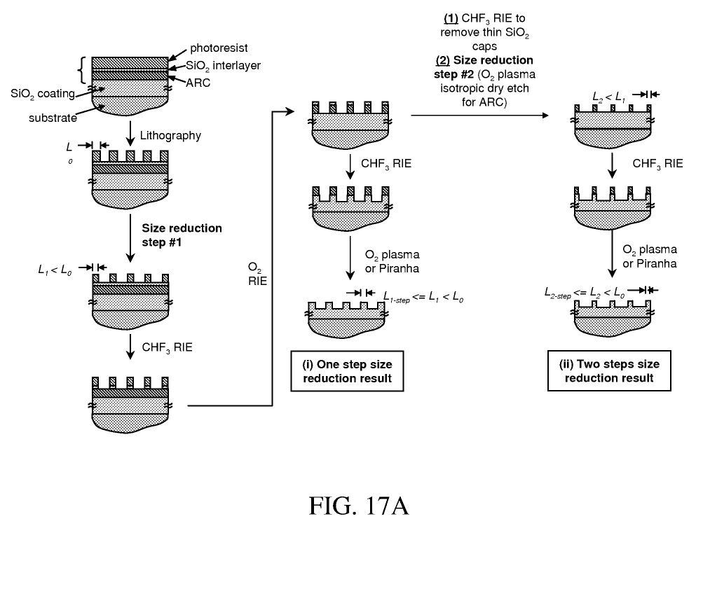

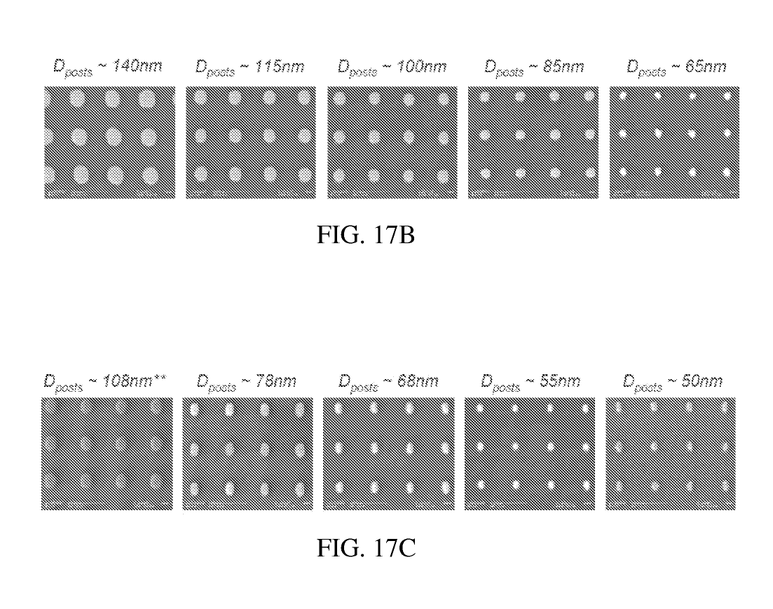

It should be understood that, at any stage or stages of the fabrication process described above, the guiding features (e.g., posts) may be reduced in size via, for example, etching techniques. For example, FIG. 17A shows a schematic representation of various stages in the fabrication of a substrate, where reduction of post size may be performed (i) after the lithography step or (ii) at two stages during the process, after the lithography step and after etching of the interlayer and/or anti-reflecting coating. FIG. 17B shows SEM images of substrates upon treatment to reduce post size after the lithography step, wherein the horizontal dimensions are reported for the elliptical posts (square lattice period ˜300 nm). FIG. 17C shows SEM images of substrates upon a two-stage post size reduction (e.g., after treatment to reduce post size after the lithography step and after etching of the interlayer and/or anti-reflecting coating). In FIGS. 17B-C, the post size reduction was performed by exposing the substrate to O₂ plasma (O₂/He 1:2, 25 mTorr, 100V/75 W).

In some embodiments, the method further comprises modification (e.g., chemical modification) and/or removal of one or more guiding features.

Polymeric materials suitable for use in the present invention include those capable of self-assembly to form a periodic structure. The polymeric materials can include, but are not limited to block polymers, blends of homopolymers, blends of block polymers, blends of homopolymers and block polymers, and polymeric materials combined with additives such as dyes, inorganic nanoparticles, liquid crystals, and the like. In certain embodiments, the systems of the present invention comprise polymeric materials, or mixtures of polymeric materials, or mixtures of polymeric materials and other, non-polymeric materials, and can include two or more distinct domains of different composition and/or physical, chemical, or dielectric properties. In some embodiments, one or more of the distinct domains of the systems can comprise non-polymeric material or void space. Examples of polymeric materials include, but are not limited to, polystyrene-b-polyferrocenylsilane, polystyrene-b-polydimethylsiloxane, polyisoprene-b-polydimethylsiloxane, and polystyrene-b-polymethylmethacrylate.

In some cases, the polymeric material can include, in addition to a polymeric species, a solvent (e.g., a non-volatile solvent) in an amount useful in swelling one or both domains, e.g. mineral oil in a polybutadiene/styrene block polymer which will swell the polybutadiene domain. This can be used to control the size of one or more domains. The polymeric material can also include other polymeric or non-polymeric additives for modification of domain dimension, other physical or chemical properties, or processibility. In addition, a suitable non-polymeric substance present in the polymeric article can also constitute a separate phase/domain within the periodic structure. For example, the size of separate polymeric domains can be controlled also via changing the volume fraction of the domain, for example by incorporation of auxiliary nanoparticles, auxiliary homopolymeric species, auxiliary monomeric or cross-linkable species that are polymerized, grafted, and/or cross-linked in situ, and the like.

The block polymers can exhibit one-, two-, and three-dimensionally periodic structures arranged into separate domains within the structure with different domains characterized by a different chemical composition and/or set of physical properties. As used herein, a “periodic structure” refers to a structure arranged so that a straight line in at least one direction which passes through the structure intersects at regular intervals at least two separate domains. For example, a “one-dimensionally” periodic structure refers to a structure which can be oriented in a three dimensional coordinate system (with mutually orthogonal X, Y, and Z component directions) so that a straight line in only one component direction will pass through the structure and intersect at regular intervals at least two separate domains. A “two-dimensionally” periodic structure refers to a structure which can be oriented in the three dimensional coordinate system so that straight lines in only two component directions will passes through the structure and intersect at regular intervals at least two separate domains. Finally, a “three-dimensionally” periodic structure refers to a structure which can be oriented in the three dimensional coordinate system so that straight lines in all three component directions may pass through the structure and intersect at regular intervals at least two separate domains. Furthermore, the term “periodic structure” as used herein refers to material with domain structures having regular periodicity as characterized by like domains having similar characteristic dimensions and spacing within the article. The term “domain,” as used herein, defines a distinct region of the structure characterized by a particular chemical composition and/or set of physical properties that differs from that of surrounding or adjacent domains.

A series of screening techniques can be used to select appropriate polymeric species for use in the invention, which include screening of constituent materials and process screening. The materials should be screened for the ability to form structures with desired characteristic domain dimensions and, where appropriate, periodic length scales. For embodiments using block polymers, this can be done by measuring the molecular weight of the block polymers using low angle laser light scattering (LALLS), size exclusion chromatography (SEC), nuclear magnetic resonance (NMR), mass spectrometry, membrane osmometry, and/or solution viscosity.

Planning and simple screening tests can be used to assess the relative compatibility of components including miscibility, phase separation, chemical stability, surface and interfacial energies, and processing stability in order to select suitable components for use as polymeric species, whether they be separate species, different blocks of a block polymeric species, or a combination. A first and second species should be comprised of components that are immiscible at an appropriate molecular weight and composition. The chi (X) parameter, which is extensively tabulated for a wide range of polymers, can be used to predict miscibility. Once a particular set of species is selected, they can be mixed (if not defined by a block polymer) and screened for suitability for use in the invention by analysis via differential scanning calorimetry (DSC). If two glass transition temperatures are observed, then the two species (or two blocks of a block polymer) are immiscible, that is, the desired phase separation has taken place. If only one glass transition temperature is observed, then the components are miscible and phase separation has not occurred, or the glass transition temperatures of the differing species or blocks are coincidentally similar. For the latter situation, if one glass transition temperature is observed, another screening test involving small angle scattering measurements, or Transmission Electron Microscopy (TEM) can determine whether phase separation has occurred. Melt temperature and the existence of crystallinity are readily determined by thermal analysis techniques such as DSC or Differential Thermal Analysis (DTA).

Processing methods should also be screened for suitability with desired materials. For example, processing temperatures should be below degradation temperatures. Also, the types and magnitude of any physical forces applied during processing should be conducive to successful assembly of periodically ordered systems, and thus should be able to guide one or more assembly/partioning events, which give rise to separate domains and a proper assembly of the domains into the periodic structure. Processing methods should be avoided that lead to the proliferation of undesired imperfections or that induce undesired chemical or physical damage to the materials or structure. The formation of a periodic structure possessing suitable characteristic domain dimensions and periodic length and composition can be verified by small angle x-ray measurements (SAXS), SEM, TEM, optical microscopy, and atomic force microscopy (AFM). These methods can also be used to inventory imperfections in the structure.

As mentioned above, a variety of polymeric species, including combinations of polymeric species, can be used to create the periodic polymeric structures of the invention. Where block polymers are used, they can be linear block polymers, “comb” block polymers, star block polymers, radial teleblock polymers, dendrimers, or a combination. Those of ordinary skill in the art can select suitable polymers or combinations of polymers to create the phase-separated structure of the invention.

In some cases, the material may comprise nanoparticles. As used herein, the term “nanoparticle” generally refers to a particle having a maximum cross-sectional dimension of no more than 1 μm. Nanoparticles may comprise inorganic or organic, polymeric, ceramic, semiconductor, metallic, non-metallic, magnetic, crystalline (e.g., “nanocrystals”), or amorphous material, or a combination of two or more of these. The nanoparticles may be also selected to be positively or negatively charged. Typically, nanoparticles may have a particle size less than 250 nm in any dimension, less than 100 nm in any dimension, or less than 50 nm in any dimension. In some embodiments, the nanoparticles may have a diameter of about 2 to about 50 nm. In some embodiments, the nanoparticles may have a diameter of about 2 to about 20 nm. The particle size may be measure by methods known in the art, such as electron microscopy.

In some cases, the nanoparticles may have a core-shell configuration. In one set of embodiments, the nanoparticles have a rigid, inorganic core with a soft-material shell (e.g., molecular or macromolecular organic soft shells). For example, the nanoparticle may have a core comprising a metal or metal-containing compound. The core may comprise a semiconductor quantum dot (e.g., CdSe, CdTe, etc.), for example, while the shell material may comprises a soft organic material, such as a polymeric or oligomeric molecule with a glass transition temperature lower than the temperature at which the templated self-assembly process is performed. The core and shell materials may be connected via covalent bonds (e.g., via a thiol or thioester) or non-covalent bonds (e.g., ionic bonds). In some cases, the nanoparticles may comprise a colloidal assembly comprising surfactant molecules.

### EXAMPLES

In the following examples, a topographical graphoepitaxy technique for controlling the self-assembly of BCP thin films that produces 2-D periodic nanostructures with precisely determined orientation and long-range order is described. In this set of embodiments, the surface of the substrate is patterned with a sparse 2-D lattice of nanoscale posts designed to act as surrogate spherical or cylindrical domains of the minor-component of the BCP. Each of these posts is designed to be chemically and physically similar to the BCP entity (the microdomain and its associated corona) for which it substitutes. The result is that the post array reduces the degrees of translational and orientational freedom of the templated BCP microdomain lattice, effectively pinning it during self-assembly. Furthermore, the spacing and orientation of the post lattice registers specific BCP lattice orientations that are commensurate with the template.

In this approach, discrete posts are distributed over the substrate, providing a set of periodic constraints that interact both locally and globally with the array of BCP domains. As described more fully below, the BCP thin film can be regarded as undergoing heteroepitaxy onto a substrate with a commensurate surface pattern. By adjusting the substrate post arrangement, a unique BCP lattice parameter and orientation can be obtained, and degenerate lattice parameters and orientations, which result in loss of long range order, can be avoided. Because the guiding posts can be designed to resemble the BCP entities both physically and chemically, they are incorporated seamlessly into the self-assembled domain array.

Chemical graphoepitaxy has been previously used to define a periodic surface-energy boundary condition onto which self-assembly of lamellar or cylindrical BCPs could occur. These surface patterns enabled defect-free 1-D periodic parallel line arrays, as well as aperiodic structures essential for device fabrication such as “L”, “V” or “T” shaped lines, to be created by replicating 1:1 the surface energy patterns. Addition of small amounts of homopolymer allowed the structures to adapt to incommensurability between template features and the period of the block copolymer. This approach involved fabrication of a chemical template with the same periodicity as the BCP, but other attempts have successfully extended the technique such that templates with a period of up to four times that of the BCP could be used to produce large-area defect-free lamellar or cylindrical domain patterns.

The BCP used in the following experiments was spherical-morphology polystyrene-b-polydimethylsiloxane (PS-b-PDMS) with molecular weight=51.5 kg/mol, minority block fraction f_{PDMS}=16.5%, and polydispersity (PDI)=1.04. This BCP was chosen because it has both a high Flory-Huggins X-parameter, giving a large driving force for microphase segregation, and a high chemical selectivity between the two blocks for subsequent pattern transfer. The BCP was spin coated to a thickness of about 50 nm and annealed at 170° C. to obtain a monolayer of 20-nm-diameter PDMS spheres with a center-to-center spacing of 38 nm in a PS matrix. In this set of embodiments, a surface layer of PDMS forms at the substrate-BCP and BCP-air interfaces due to the low surface energy of PDMS. By using CHF₃ followed by oxygen-plasma reactive-ion etching (RIE), the PS matrix was removed to reveal the oxidized PDMS domains.

### Example 1

The following example describes fabrication of a topographically patterned substrate for use as a BCP template, according to one embodiment of the invention. Generally, the templates were fabricated using electron beam patterning of hydrogen silsesquioxane (HSQ), a negative-tone electron resist. HSQ is a radiation-sensitive spin-on-glass that forms a silica-like material directly upon electron-beam exposure. In this example, HSQ films were spin-coated on silicon substrates, and single-pixel dots were exposed in a Raith 150 electron-beam lithography tool at 30 kV acceleration voltage. The samples were developed in a high-contrast developer system as described previously, and further treated with O₂/He plasma (50 W, 2 min) to remove possible organic residues.

In one experiment, a sparse 2D array of posts created by electron-beam lithography of a 40 nm thick hydrogen silsesquioxide (HSQ) resist layer on a Si substrate was fabricated. Development revealed the exposed posts, without requiring further etching or processing. The surface of the posts were fabricated to exhibit affinity towards one of the domains of the BCP. In this example, the affinity was established by chemical functionalization of the template surface with either PS or PDMS brushes. A 30 nm layer of hydroxyl-terminated homopolymer (PS—OH with a molecular weight of 10 kg/mol, or PDMS-OH, 5 kg/mol) was spin coated onto the substrate, which was then annealed at 170° C. for 15 hours, The unreacted homopolymer was removed with toluene.

### Example 2

The following example describes the templating of BCP films using substrates as described herein.

PS-b-PDMS films (50 nm-thick, 51.5 kg/mol, f_{PDMS}=16.5%, PDI=1.04) were obtained by spin-casting from a toluene solution of the PS-PDMS block copolymer (2.5% by weight) on functionalized substrates, then the samples were vacuum annealed at 200° C. for 12 hours. The annealed film was treated with a 5 s, 50 W CF₄ plasma to remove the PDMS surface layer, then a 30 s, 90 W O₂ plasma to remove the PS domains, leaving oxidized PDMS dots on the substrate. The surface morphology was observed using a Raith 150 SEM operated with an acceleration voltage of 10 kV. A thin layer of Au—Pd alloy was sputter-coated on samples in order to avoid charging effects.

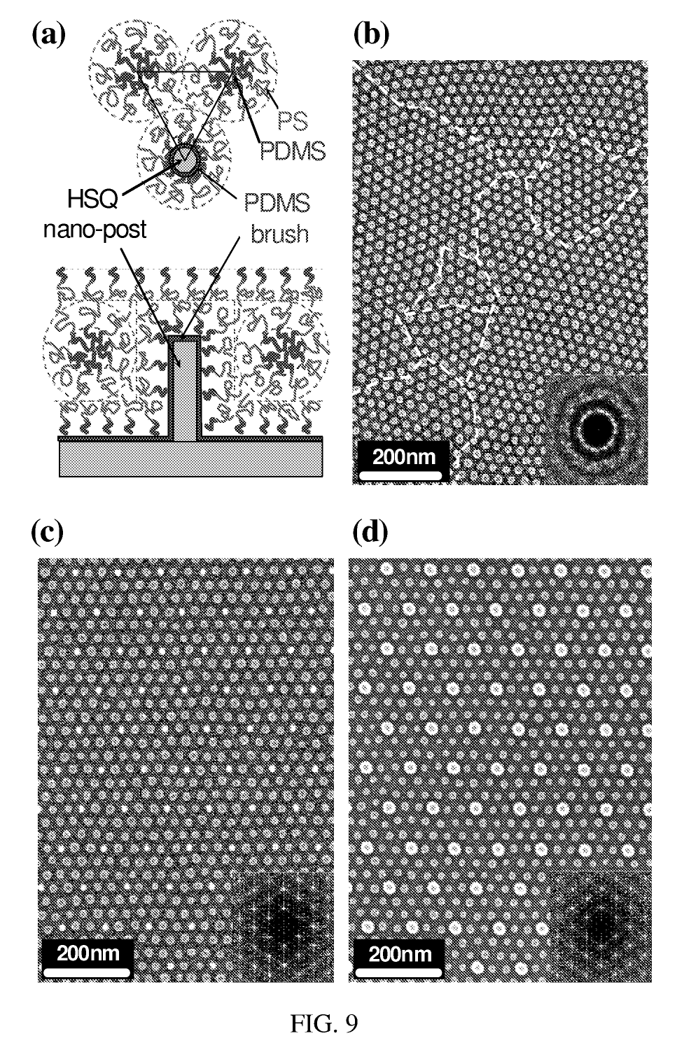

FIG. 9A includes top-down and side-view schematic representations of PS-b-PDMS block copolymer molecules in the region surrounding a single post made from cross-linked HSQ resist, wherein the post and substrate surfaces have been chemically functionalized by a monolayer of short-chain PDMS brush. The posts act as substitutes for a PDMS sphere in the close-packed array. In an alternative design, an array of larger-diameter posts was functionalized with a PS homopolymer brush. PDMS brush-coated substrates were mainly used due to improved ordering of PS-b-PDMS BCP microdomain arrays on PDMS-coated substrates, compared to PS-coated substrates. The use of PDMS brush-coated posts, which required the ability to fabricate ˜10-nm structures lithographically, was enabled by recent high-resolution development methods in electron-beam lithography.

FIG. 9B shows an scanning-electron micrograph (SEM) image of a disordered monolayer of BCP spherical domains formed on a flat surface, i.e. without templating. The boundaries between different grain orientations are indicated with dashed lines. The inset in FIG. 9B shows a two-dimensional (2D) Fourier transform of the domain positions which shows the absence of long range order. By contrast, FIG. 9C shows an SEM image of ordered BCP spheres formed within a sparse 2D lattice of HSQ posts (brighter dots), wherein the substrate and post surfaces were functionalized with a PDMS brush layer. FIG. 9D shows an SEM image of ordered BCP spheres formed within a sparse 2D lattice of HSQ posts (brighter dots), wherein the substrate and post surfaces were functionalized with a PS brush layer. The BCP microdomains form an ordered lattice with a factor of 3 increase in spatial frequency over that of the post lattice. The insets of FIGS. 9C-D show the 2D Fourier transforms indicating a high degree of 2D lattice order. The high frequency components of the Fourier transform originate from the post lattice.

As noted above, FIGS. 9C and 9D show that appropriately sized and functionalized posts could template the assembly of a BCP lattice, while FIG. 9B shows the results of untemplated assembly for the same BCP. The template in FIG. 9C consisted of ˜12 nm diameter HSQ posts functionalized with PDMS (5 kg/mol) of ˜2 nm thickness resulting in a post diameter of ˜16 nm. FIG. 9D shows results from 20-nm-diameter HSQ posts functionalized with PS (10 kg/mol) of ˜5 nm thickness, resulting in a post diameter of 30 nm. In both cases, defect-free close-packed PDMS sphere arrays formed on the templates. In the SEM images, the HSQ posts appear brighter and of a different diameter compared with the oxidized PDMS spheres.

### Example 3

Having shown that a close-packed array of posts could template an ordered BCP array with a spatial frequency which is an integer multiple of the template frequency, a more general problem was considered: how sparse could the template be designed to ensure the formation of a ‘single grain’ BCP lattice of controlled period and orientation. For a close-packed template of period Lₚₒₛₜ, and a close-packed BCP microdomain array of period L<Lₚₒₛₜ, the commensurability between the BCP lattice and the template depends on the ratio Lₚₒₛₜ/L. In the simplest case, where Lₚₒₛₜ/L is an integer, the lattice vectors of the template and the array are parallel, as seen in the SEMs of FIG. 9, where Lₚₒₛₜ/L=3, and θ, the angle between the post lattice and BCP microdomain lattice basis vectors, is zero. For non-integer values of Lₚₒₛₜ/L, however, a variety of commensurate BCP lattices with orientations θ≠0 can also occur. As shown in the supplemental information, when a basis vector of the post lattice is equal to the sum of integer multiples i and j of the two 60°-oriented basis vectors of the BCP microdomain lattice,

Lₚₒₛₜ/L=\sqrt{i²+j²+ij} (1)

and the angle θ between the post lattice and BCP microdomain lattice is given by

$$θ = arc cos ( \frac{2 i + j}{2 \sqrt{{i}^{2} + {j}^{2} + ij}} ) . \qquad ( 2 )$$

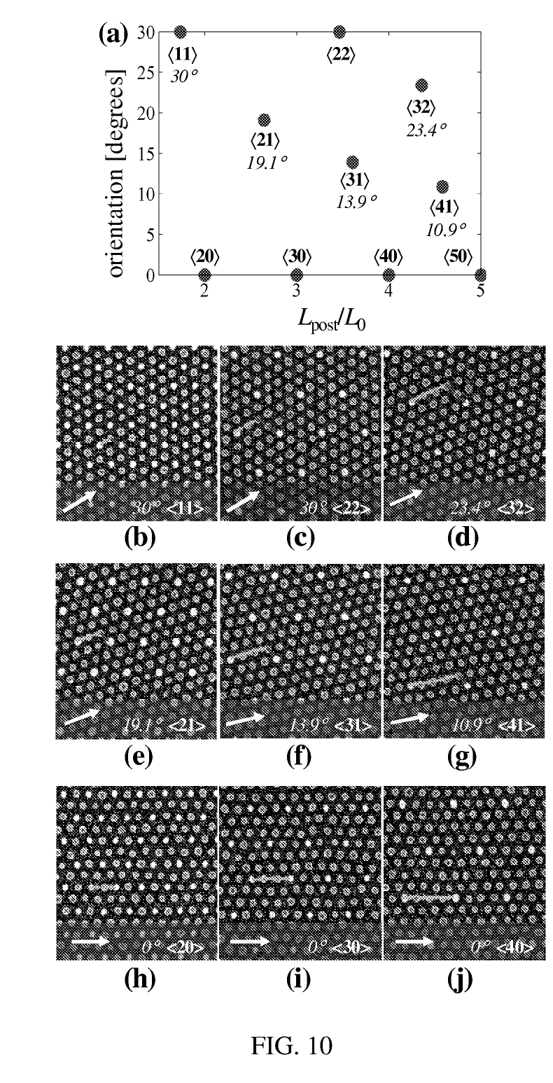

Notation of the form <ij≦ is used to describe possible commensurate BCP lattice configurations. For example, the structures shown in FIGS. 9c and 9d would be labeled as <30> under this notation. FIG. 10A presents a map of the mathematically possible commensurate lattice configurations where the Lₚₒₛₜ/L ratio was varied continuously up to Lₚₒₛₜ/L=5. In this range, six different values of θ (in the interval 0≦θ≦30°) of the BCP lattice may be obtained. For each of these <ij> orientations, the number of domains templated by each post is given by i²+j²+ij−1, for example, 8 BCP domains are templated per post for <30> and 26 for <33>. The post lattice is analogous to a coincident site lattice (CSL) of the BCP lattice, in which smaller <ij> values correspond to smaller CSL sigma-values and a greater number of coincident post and BCP lattice sites. Thus, as shown in FIG. 10A, the BCP lattice is commensurate with the post lattice when the post lattice basis vectors of length Lₚₒₛₜ can be represented as integer multiples, <ij>, of the BCP lattice basis vectors. Due to the 6-fold symmetry of the BCP lattice, the angular span of 0 to 30° is sufficient to represent all possible non-degenerate orientations.

FIGS. 10B-J show SEM images of orientations observed within the range Lₚₒₛₜ/L=1.65 to 4.6, for (b) a <11> orientation where θ=30°, (c) a <22> orientation where θ=30°, (d) a <32> orientation where θ=23.4°, (e) a <21> orientation where θ=19.1°, (f) a <31> orientation where θ=13.9°, (g) a <41> orientation where θ=10.9°, (h) a <20> orientation where θ=0°, (i) a <30> orientation where θ=0°, and (j) a <40> orientation where θ=0°. These orientations agree with the predictions in FIG. 10A. The white arrows show the orientation angle between the BCP microdomain lattice and the post lattice and are 120-nm long. The brighter dots are the oxidized HSQ posts, while the darker dots correspond to oxidized PDMS spherical domains. The blue and red arrows indicate the basis vectors of the BCP microdomain lattice, and sum to one horizontal basis vector of the post lattice.

Regarding strain in the BCP lattice, BCP arrays may develop a tensile or compressive strain in order to fit within a template, as observed in confined spherical, cylindrical or lamellar arrays. Confined BCP arrays are capable of exhibiting significant strain, with tension being easier to accommodate than compression. This compliance enables a greater number of configurations to be experimentally accessed at particular values of Lₚₒₛₜ/L than the discrete results in FIG. 10A would suggest. The ability of the BCP microdomain lattice to deform elastically therefore enables multiple BCP arrangements to form on a given post lattice, each with a different lattice parameter and orientation θ.

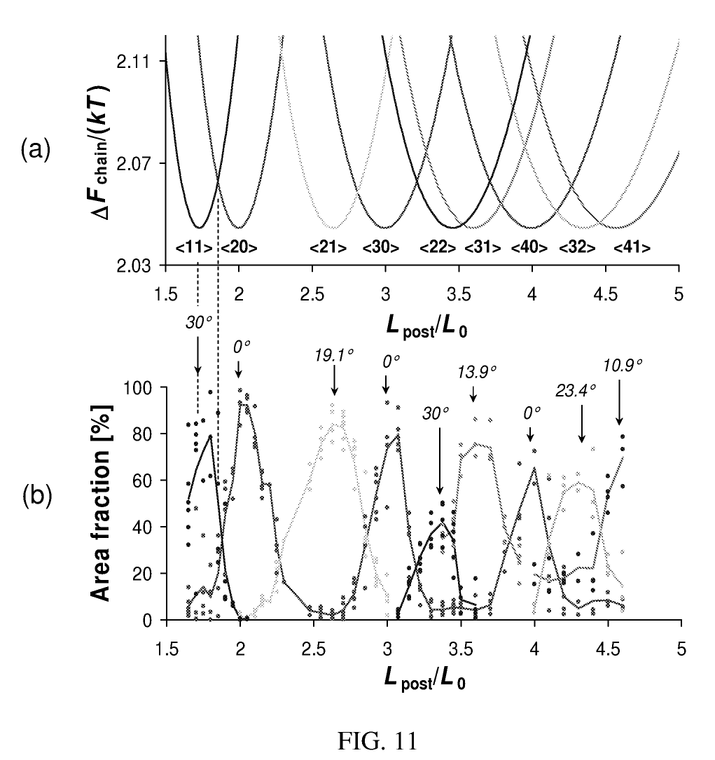

In order to predict the configuration(s) that will form, a simple free energy model for the BCP microdomain lattice as a function of Lₚₒₛₜ/L was considered. Given an <ij> configuration and a post spacing such that the commensurate sublattice period L differs from the equilibrium spacing of the BCP on a flat substrate, L₀, the templated BCP may either assume a strained spacing and fit inside the post-lattice, or form local defects and relieve the long-range stress. The free-energy change for straining the BCP lattice can be approximated under an affine deformation model by considering the effect of strain on both the conformational entropy of a polymer chain and the interfacial energy between the BCP domains. The derivation of the free energy expression is described in the supplemental information, and leads to

$$Δ {F}_{chain} / kT = \frac{2 Mb}{L} \sqrt{\frac{{χ}_{AB}}{6}} + \frac{1}{2} ( \frac{{L}^{2}}{4 {Mb}^{2}} + \frac{4 b \sqrt{M}}{L} - 3 ) \qquad ( 3 )$$

where L is the strained BCP spacing required for the BCP lattice to be commensurate with the template for the considered <ij> configuration, M is the number of statistical segments of the BCP chain, b is the statistical segment length, χ_{AB} is the Flory-Huggins interaction parameter, k is Boltzmann's constant, ΔF_{chain} is the free energy per BCP chain, and T is the temperature. L₀ was obtained by minimizing this expression and solving for L. ΔF_{chain}/kT was then calculated for all the <ij> combinations by substituting L=Lₚₒₛₜ/\sqrt{i²+j²+ij}. FIG. 11A shows the calculated curves of free energy per BCP chain vs Lₚₒₛₜ/L₀ for each commensurate configuration. Free energy minima occur at Lₚₒₛₜ/L₀ values where the commensurate condition is satisfied without straining the BCP microdomain array. Each distinct <i j> lattice has an energy-well with a minimum corresponding to the value of Lₚₒₛₜ/L₀ at which the post lattice is commensurate with an unstrained BCP microdomain lattice.

The predictions of this model were tested by preparing templates with the range of Lₚₒₛₜ=66-184 nm (Lₚₒₛₜ/L₀˜1.65-4.6) on a single substrate. Each template region consisted of posts covering a hexagonal area with a diameter of 4 μm. Having multiple templates on the same substrate ensured a uniform BCP film thickness (and hence the same L₀) across all templates with different Lₚₒₛₜ values. Scanning electron micrographs often showed more than one BCP microdomain lattice orientation within each post array. Image analysis was used to determine the (x,y) coordinates and Wigner-Seitz cells for each BCP lattice site, and the area and orientation of each Wigner-Seitz cell was calculated to determine the area fraction of each BCP lattice orientation (see supplemental information). The experimental results are shown in by the graph in FIG. 11B, where the area fraction of each <ij> lattice is shown as a function of Lₚₒₛₜ/L₀. Each filled circle is a data point obtained by image processing of an SEM image of a 1.3 μm by 1.3 μm square area of the templated region. This plot was generated from data collected from over 200 images of different post lattices on the same substrate. The solid line connects the average values of the data points for a given Lₚₒₛₜ/L₀. As Lₚₒₛₜ was varied, we see different BCP orientations dominating.

As shown in FIG. 11B, the predicted ΔF_{chain} minima and intersection points were in good agreement with the experimental results, as indicated by the vertical dashed lines. For example, three maxima for the 0° orientation correspond to lattices <2 0>, <3 0> and <4 0>, and two maxima for the 30° orientation correspond to <1 1> and <2 2>. As Lₚₒₛₜ varied, different BCP microdomain lattices dominated on the template. As expected, these situations corresponded to commensurate Lₚₒₛₜ/L₀ values for which the free energy model also predicted a minimum. Furthermore, there was good agreement between the predictions of the model and experimental results as to the Lₚₒₛₜ/L₀ values at which the system transitioned between two orientations. For the higher values of Lₚₒₛₜ/L₀, greater than ˜3.5, there was no BCP lattice orientation that completely filled the template, so that the samples all showed two or more different BCP lattice orientations. This effect can be understood as being due to the increasing width and number of the potential wells, such that the energy barriers separating different BCP orientations became smaller. A similar phenomenon was observed in previous work with BCP spheres packing in grooves, where N or N+1 rows of spheres were observed to occur degenerately for wider grooves.

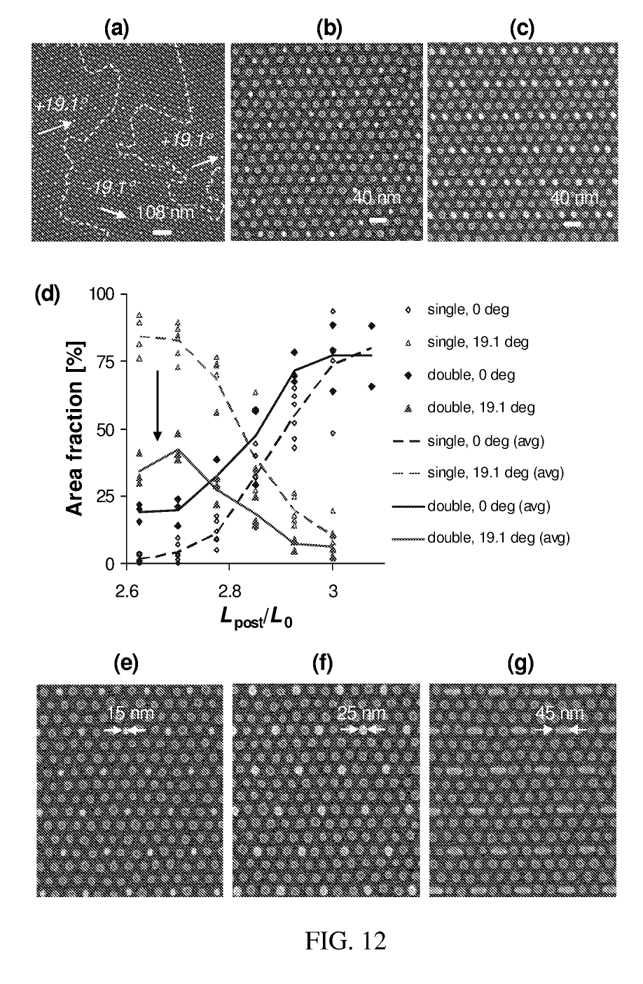

Control of the final self-assembled lattice by design of the template parameters was also considered. The analysis above showed how a given BCP microdomain lattice <i j> could be selected by choice of Lₚₒₛₜ/L₀, and predicted what strain the BCP microdomain lattice experienced when fitting the post lattice. However, it did not address selection between degenerate lattice orientations. For example, FIG. 12A shows an SEM image showing two degenerate <2 1> BCP microdomain lattice orientations (i.e. +19.1° and −19.1°) forming on one post lattice. The white dashed lines represent grain boundaries while the arrows show the grain orientations. The periodic post lattice was commensurate with both orientations. Two variants of lattice <2 1> could be formed when Lₚₒₛₜ/L₀˜2.6, with orientations of θ=+19° or −19°, as shown in FIG. 12A. For a 6-fold symmetrical post lattice, there was no preference for either orientation. However, a preference could be established by adding posts that occupied microdomain lattice sites of only one of the possible variants. FIG. 12B shows an SEM image of a unique BCP microdomain lattice orientation obtained by breaking the periodicity of the post template with an aperiodic sparse arrangement of posts positioned at randomly chosen lattice points on the BCP lattice. As shown in FIG. 12B, a defect-free BCP microdomain lattice was formed using a sparse aperiodic post lattice which selected for a unique BCP orientation. The template was formed by randomly removing posts from the original periodic post lattice and adding posts that matched only the desired BCP (21) lattice variant. Templates were also designed to reduce the incidence of one lattice type, for example (21), compared to a competing orientation such as (30).

Alternative template designs were also used to achieve unique BCP lattice formation. FIGS. 12C-D show how this was accomplished by a template whose motif consisted of pairs of posts. For example, FIG. 12C shows an SEM image of a motif including pairs of posts. With this template, the formation of BCP lattice orientations other than the 0° <30> lattice were frustrated. FIG. 12D show a plot of area fraction versus Lₚₒₛₜ/L₀ for two template designs, single-post and double-post lattices. The arrow shows a reduction in area percentage (or frustration) of the 19.1° <21> orientation when a double-post lattice template was used. A template of single posts showed a gradual transition between <21> and <30> lattices as Lₚₒₛₜ/L₀ increases from 2.8 to 3.0. However, with the post pair motif, the (21) orientation was frustrated and occupied a smaller area fraction of the substrate, even at Lₚₒₛₜ/L₀=2.6 where (21) gave the optimum lattice match with the template. The quality of the BCP microdomain lattice is relatively insensitive to the exact shape and size of the posts.

FIGS. 12E-G show well-ordered <30> lattices formed on three templates with identical period but differing post size and shape. FIG. 12E shows an SEM image of a BCP <30> array guided by pillars having a 15 nm diameter, but with equal center to center spacing of 120 nm, while FIG. 12F shows an SEM image of a BCP <30> array guided by pillars having a 25 nm diameter, also with equal center to center spacing of 120 nm. FIG. 12G shows an SEM image of a well-ordered BCP <30> array guided by pillars having a cross-section in the shape of 45-nm×25-nm ellipses, with equal center to center spacing of 120 nm. This tolerance may be useful as it lowers the precision requirements on the template fabrication process.

The elimination of defects in the templated BCP array, and the absolute registration of domain positions, may be useful in lithographic applications. In non-templated films, the largest defect-free regions observed, in this example, were on the order of 0.4 μm×0.4 μm. On the other hand, in the templated case defect-free arrays were observed over 2-μm or greater distances for Lₚₒₛₜ/L₀<˜3. In cases where only one BCP lattice orientation existed, any defects that did occur did not disrupt the long-range orientation of the array, as the self-assembled structure remained in phase with the periodic boundary condition introduced by the template: any point defect that occurred only affected the coordination number and spacing of nearby spherical domains. In the templated arrays, as the BCP microphase-separated, close-packed regions of domains are assumed to have nucleated around the posts, grown, and impinged; since the orientation of these small regions was fixed by the template, this locally registered nucleation of the lattice led to a macroscopically ordered BCP array, even if some 5 and 7 coordinated spheres remained. This situation contrasts with the case of untemplated arrays, where such defects would lead to a ‘polycrystalline’ BCP microdomain lattice structure and a loss of long range correlation. For larger Lₚₒₛₜ/L₀, a slightly larger defect frequency was observed, which was attributed to the overlapping potential wells of the BCP lattices, leading to coexistence of different lattices and the presence of defects associated with their boundaries.

The examples describe methods for templating the self-assembly of block copolymer microdomains in thin films, based on employing a sparse array of nanoscale posts to direct the formation of 2D single crystals of microdomains with precisely determined orientation, location and period. The post diameter and surface chemistry were chosen such that each post substituted for a single microdomain entity in the array, effectively pinning spatially the lattice. By varying the 2D arrangement of the posts, BCP microdomain lattices with a range of orientations were selectively produced. For example, specific BCP lattice orientations were promoted by designing the motif of the template array, and by making the template aperiodic. In these experiments, each post templated between 2 and 20 block copolymer microdomains. One advantage of the methods described herein is that any defects occurring in the array exhibited minimal and highly localized effect. That is, the long-range order of the BCP remained undisturbed and in phase with the 2D periodic topographical boundary condition of the template.

Although this work was performed using a spherical morphology PS-b-PDMS diblock copolymer, the technique may be applied to block copolymers with perpendicular cylindrical morphology, lamellar structures, or the like. Indeed, the perpendicular cylinder morphology, which lacks the ability to adjust the positions of its domains along the direction normal to the surface, may produce arrays with even better placement accuracy than the accuracy demonstrated here, and high aspect ratio features may also be produced by this technique. These well-ordered block copolymer arrays may be useful as etch masks in a range of applications, such as patterned recording media, which require periodic nanoscale features covering large areas. This templating approach thus provides a method of combining top-down and bottom-up nanopatterning techniques, where information is placed on the substrate by writing a dilute lattice of posts, and the self-assembling material spontaneously populates the empty spaces on the template with a seamless nanostructured array of determined orientation and lattice spacing.

### Example 4

The following example describes analysis of the BCP sublattice orientations templated by a post lattice. A template consisting of cylindrical posts arranged on a hexagonal lattice with period Lₚₒₛₜ and a derivation of the possible configurations where the post superlattice is commensurate with a 2D hexagonal lattice of spatial period L<Lₚₒₛₜ corresponding to the BCP thin film domain morphology is described below.

In general, commensurate configurations can be obtained by using any vector \vec{r}ᵢⱼ in the BCP lattice as one of the basis vectors of the post lattice:

Lₚₒₛₜ\hat{b}₁=\vec{r}ᵢⱼ (S-1)

where \hat{b}₁ is one of the basis vectors of the post lattice (together with a second vector generated by a 60° rotation of \hat{b}₁), and

\vec{r}ᵢⱼ=L(iâ₁+jâ₂) (S-2)

where i and j are integers and â₁ and â₂ are the unit vectors of the BCP lattice (defined at 60° from each other).

The post lattices that correspond to each unique pair i and j are defined by

Lₚₒₛₜ=|\vec{r}ᵢⱼ|=L|iâ₁+jâ₂|=L\sqrt{i²+j²+ij}. (S-3)

The notation <ij> is used to index the possible BCP lattice configurations with respect to the post lattice.

The orientation of the post lattice with respect to the BCP lattice can be described by using the angle θformed between \vec{r}ᵢⱼ and â₁:

$$θ = arc cos ( \frac{2 i + j}{2 \sqrt{{i}^{2} + {j}^{2} + ij}} ) \qquad ( S \text{-} 3 )$$

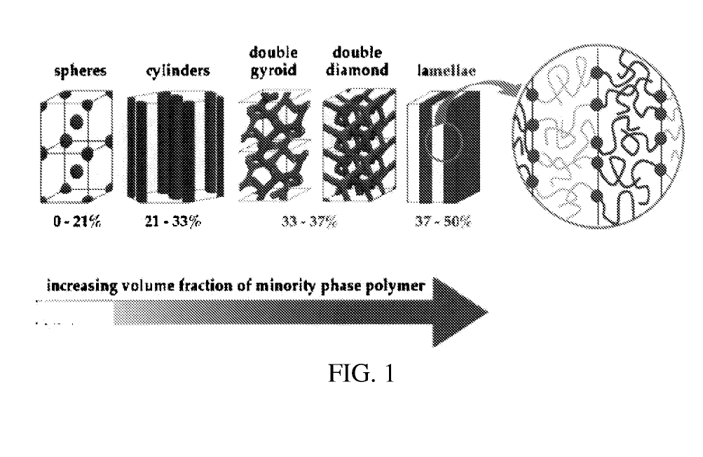

The table below lists all the possible angles for the case when i, j≦5. A map of the lattice orientations is shown in FIG. 1a for Lₚₒₛₜ/L<5. For each angle, a family of lattices exists corresponding to multiples of i and j, e.g. at θ=0 the family is <10>, <20>, <30>, etc.

TABLE 1
<ij> commensurate post lattice spacing and orientations corresponding
to the 11 unique \vec{r}ᵢⱼ directions in a 2D hexagonal BCP lattice with
i, j ≦5 and spacing L.

| Lattice | i | j | Lₚₒₛₜ/L | θ [°] |
|---|---|---|---|---|
| <10> | 1 | 0 | \sqrt{1} = 1.00 | 0.0 |
| <11> | 1 | 1 | \sqrt{3} = 1.73 | 30.0 |
| <21> | 2 | 1 | \sqrt{7} = 2.65 | 19.1 |
| <31> | 3 | 1 | \sqrt{13} = 3.61 | 13.9 |
| <32> | 3 | 2 | \sqrt{19} = 4.36 | 23.4 |
| <41> | 4 | 1 | \sqrt{21} = 4.58 | 10.9 |
| <51> | 5 | 1 | \sqrt{31} = 5.57 | 9.0 |
| <43> | 4 | 3 | \sqrt{37} = 6.08 | 25.3 |
| <52> | 5 | 2 | \sqrt{39} = 6.24 | 16.1 |
| <53> | 5 | 3 | \sqrt{49} = 7.00 | 21.8 |
| <54> | 5 | 4 | \sqrt{61} = 7.81 | 26.3 |

The next step is to determine how many BCP domains are templated by a given post for each of the BCP lattices <ij>. The table below shows for some of the lattices the number n of domains templated by each post and the number m of unit cells of the BCP lattice per unit cell of the post lattice. Note that m=n+1=i²+j²+ij.

TABLE 2
The number of BCP domains templated by each post of the lattice,
and the number of BCP unit cells per lattice unit cell, for several
BCP lattices <ij>.

| | n = | | |
|---|---|---|---|
| | number | | |
| | of BCP | | |
| | domains | | |
| | templated | m = number of | |
| | by each | BCP unit cells per | |
| | lattice | unit cell of the | |
| Lattice | post | post lattice | i² + j² + ij |
| <10> | 0 | 1 | 1 |
| <20> | 3 | 4 | 4 |
| <30> | 8 | 9 | 9 |
| <40> | 15 | 16 | 16 |
| <50> | 24 | 25 | 25 |
| <11> | 2 | 3 | 3 |
| <22> | 11 | 12 | 12 |
| <33> | 26 | 27 | 27 |
| <21> | 6 | 7 | 7 |

### Example 5

The following example includes the description of a simple free energy model developed to describe a BCP lattice that is allowed to undergo in-plane strain in order to achieve commensuration on a given periodic template. The previous section and FIG. 10a described the case of perfect commensuration, where for most Lₚₒₛₜ/L values there is only one possible orientation between the BCP lattice and the post lattice. However, the BCP lattice may be able to adopt multiple orientations for a given Lₚₒₛₜ by slightly expanding or compressing itself so that commensuration is achieved at particular values of the Lₚₒₛₜ/L ratio in the range available to a strained BCP lattice with period L≠L₀, with L₀ the equilibrium spacing.

For each <ij> configuration of interest, the templated BCP lattice spacing is:

$$L = \frac{{L}_{post}}{\sqrt{{i}^{2} + {j}^{2} + ij}} \qquad ( S \text{-} 4 )$$

In order to derive a free energy model, ΔF, an affine deformation where the relative deformation of an individual BCP chain is the same as the macroscopic strain, λ, of the BCP lattice is assumed. For hexagonal symmetry in 2D, the elastic modulus is isotropic, justifying the use of a 1D strain model. The free energy change per A-B diblock copolymer chain can be defined as:

ΔF_{chain}=ΔH−TΔS=γ_{AB}A−TΔS_{conf} (S-5)

where γ_{AB}=interfacial tension, A=interface area per chain, T=temperature, and ΔS_{conf}=change in conformational entropy per chain.

The change in conformational entropy for a strained ideal polymer network is:

$$Δ {S}_{conf} = - \frac{k}{2} ( {λ}_{x}^{2} + {λ}_{y}^{2} + {λ}_{z}^{2} - 3 ) \qquad ( S \text{-} 6 )$$

where k=Boltzmann constant, and λᵢ are the strains in the i=x, y, z directions. Further assuming an incompressible system (Πλᵢ=1) and that λₓ=λ, the entropy term becomes:

$$Δ {S}_{conf} = - \frac{k}{2} ( {λ}^{2} + \frac{2}{λ} - 3 ) \qquad ( S \text{-} 7 )$$

The strain is calculated with respect to a Gaussian coil reference state:

$$λ = \frac{L / 2}{b \sqrt{M}} \qquad ( S \text{-} 8 )$$

where b=statistical segment (Kuhn) length, and M=number of statistical steps.

The enthalpic contribution to ΔF_{chain} is related to the change in interfacial energy upon deformation of the polymer chain. The interfacial tension between the A and B blocks of an A-B diblock copolymer can be estimated from the Helfand-Tegami expression for the interfacial energy between A and B homopolymers:

$${γ}_{AB} = \frac{kT}{{b}^{2}} \sqrt{\frac{{χ}_{AB}}{6}} \qquad ( S \text{-} 9 )$$

where χ_{AB} is the Flory-Huggins interaction parameter between the A and B blocks of the diblock copolymer.

The interface area for the microphase separated chain can be estimated as:

$$A ≅ \frac{{V}_{chain}}{L / 2} = \frac{2 {Mb}^{3}}{L} \qquad ( S \text{-} 10 )$$

where half the BCP spacing is chosen to correspond to the length of one chain.

Thus, by using Eqs. (S7-S10), the following expression for the free energy can be derived:

$$Δ {F}_{chain} / kT = \frac{2 Mb}{L} \sqrt{\frac{{χ}_{AB}}{6}} + \frac{1}{2} ( \frac{{L}^{2}}{4 {Mb}^{2}} + \frac{4 b \sqrt{M}}{L} - 3 ) \qquad ( S \text{-} 11 )$$

In order to use this model to compare with the experimental results shown in FIG. 11a, Eq. (S-11) is minimized with respect to L and an equilibrium spacing, Lₒ, is determined corresponding to the assumed parameters: χ_{AB}=0.18 (at 200° C., the sample anneal temperature), M=231, and b=0.56 nm (estimated as a weighted mean of the Kuhn steps for PS and PDMS reported elsewhere). For each experimental post spacing, the templated BCP spacing (Eq. S-4) is calculated, and then the free energy corresponding to that spacing is calculated from Eq. (S-11). The free energy is plotted versus Lₚₒₛₜ/L₀ in FIG. 11a for a direct comparison with the experimental results of FIG. 11b.

### Example 6

The following example describes a procedure for SEM image analysis and determination of BCP grain orientations.

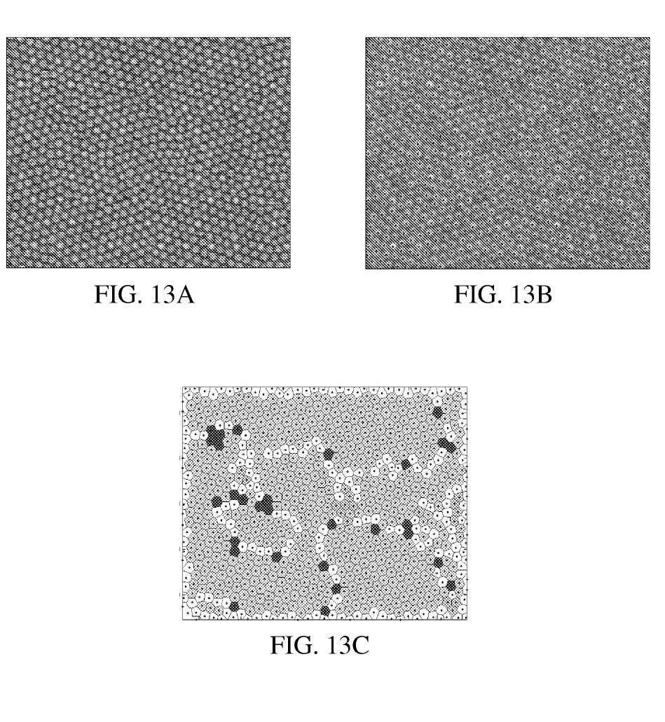

A computer program written in Matlab was developed to analyze the electron microscope images. The steps of the analysis process are as follows. First, a scanning electron microscope image is acquired, such as the one shown in FIG. 13A. The center for each dot (oxidized BCP sphere, or template posts) in the image is identified by correlation of the image with a disk the size of a dot, as shown in FIG. 13B. A Voronoi diagram is generated, as shown in FIG. 13C, and the orientation of the BCP dot lattice with respect to the post lattice calculated at each point. In this case, blue=+/−19°, red 30°, and green=0°. Cells without color are either defects or have vertices outside the frame (e.g. near the edges of the image).

### Example 7

The following example describes the fabrication of a substrate comprising a periodic arrangement of posts. In this example, two layers are added between the photoresist and the substrate in order to increase the nanoscale fidelity of the final structure (e.g., “tri-layer resist”).

FIG. 15A shows a tri-layer resist stack including a silicon substrate and a photoresist. Additionally, there are two layers added between the photoresist and the substrate, including an anti-reflection coating (ARC) and a pattern transfer layer. The function of the ARC is to minimize the reflection R2 at the bottom interface of the photoresist layer. The optically thin pattern transfer interlayer was placed between the ARC and the photoresist layers in order to improve the fidelity with which the periodic or quasiperiodic pattern is transferred into the substrate. This can be achieved by choosing an interlayer material that is substantially not affected by typical etching processes used for structuring both the photoresist and the ARC layers.

The clean room fabrication process used to prepare 2D PQC samples with various rotational symmetries is shown in FIG. 15, and the materials and deposition details are summarized in Table 3.

In this example, a positive rather than a negative photoresist was chosen. The initial tri-layer resist stack included a 200 nm photoresist, a 20 nm SiO₂ interlayer, and a 200 nm organic ARC material formed on a 1.5 micron thermal oxide-coated silicon wafer substrate. (FIG. 15A) Lithography (e.g., interference lithography) was used to pattern the photoresist. (FIG. 15B) As shown in FIG. 15C, dry etching was used to “project” the photoresist structure into the ˜20 nm thin SiO₂ interlayer (e.g. RIE with CHF₃ or CF₄ gases). The resulting structure was then transferred into the organic-material based ARC layer by etching with O₂ RIE using the thin SiO₂ caps as a mask, as shown in FIG. 15D. Thus, the photoresist acts as a dry etch mask for the SiO₂ interlayer, which then becomes the etch mask for the organic ARC, which is the mask used to etch the pattern into the substrate. (FIG. 15E) The final substrate was obtained by removal of the ARC mask with oxygen plasma, as shown in FIG. 15F.

FIG. 15(i)-(iv) show SEM images of various stages of the process described above. FIG. 15(i) shows an SEM image of the substrate upon dry etching of the SiO₂ interlayer. FIG. 15(ii) shows an SEM image of the substrate upon dry etching of the ARC layer. FIG. 15(iii) shows an SEM image of the substrate upon dry etching of the substrate. FIG. 15(iv) shows an SEM image of the final substrate upon removal of the ARC mask with oxygen plasma.

TABLE 3
Materials, deposition techniques, and their refractive indices used in the
tri-layer process, listed in order of deposition.

| | | | Refractive index |
|---|---|---|---|
| Label | Material | Deposition | at 325 nm* |
| substrate | 1.5 μm thermal oxide on silicon, | n/a | Si: 4.68-2.03i |
| | from WaferNet Inc. | | SiO₂: 1.48 |
| ARC | AZ BARLi Coating, from Clariant | spin coat, 6500 rpm | 1.55-0.14i |
| | Corporation. | (thickness ~200 nm**) | |
| | | bake 90 sec at 175° C. | |
| interlayer | silicon oxide, SiO₂ | e-beam evaporation | 1.48 |
| | | (thickness 15-20 nm) | |
| photoresist*** | PFI-88 A2 (positive resist) from | spin coat****, 4000 rpm | 1.79-0.02i |
| | Sumitomo Chemical Co. Inc. | (thickness ~200 nm) | |
| | | bake 90 sec at 90° C. | |

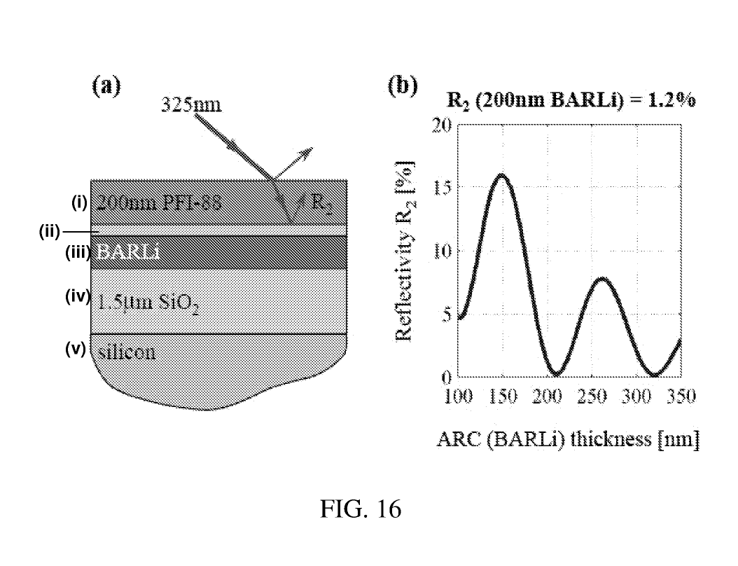

*Measured using spectroscopic ellipsometry by Dr. Michael Walsh.
**ARC thickness is changed according to the period to be recorded, such that the reflection at the bottom interface of the photoresist is minimized (see FIG. 16B). The reported thickness value corresponds to 300 nm period lines.
***A photoresist adhesion promoter was first spun on the SiO2 interlayer (hexamethyl disilazane, HMDS, which forms a hydrophobic trimethyl-siloxane self assembled monolayer coating on SiO2). Without this adhesion promoter the photoresist pattern dewets in the developer solution.
****The photoresist was developed with a tetramethyl ammonium hydroxide aqueous-based solvent, Microposit CD-26 from Rohm & Haas.

The refractive index data shown in Table 3 was used to calculate the thickness of the ARC layer for a desired line grating periodicity. The incidence angle can be determined, and then a transfer matrix technique can be used to calculate the reflectivity at the bottom interface of the photoresist (e.g., R2, shown in FIG. 14) from the upper propagating component of the electric field inside the photoresist layer. ARC thicknesses for which R2<5% can be used for obtaining line gratings with good vertical profiles. FIG. 16A shows the tri-layer resist stack structure including, from the top, a photoresist, a SiO₂ interlayer, an ARC layer and substrate (1.5 micron thermal oxide on silicon). FIG. 16B shows a graph of the reflectivity as a function of ARC layer thickness, in the case of a 300 nm period grating. The simulations used the refractive index data shown in Table 3.

The RIE dry etching steps shown in FIG. 15 were performed in the Nanostructures Laboratory class 100 clean room using a PlasmaTherm 790 Series System VII (13.56 MHz RF source) with the process parameters shown in Table 4.

TABLE 4
Reactive ion etching (RIE) process parameters. For all gases, the total
flow rate was 15 sccm.

| Material | | | | |
|---|---|---|---|---|
| to be etched | Gas | Pressure | DC Bias/Power | Etch rate |
| SiO₂ | CHF₃ | 10 mTorr | 300 V/150 W | ~27 nm/min |
| ARC | O₂/He (1:2) | 7 mTorr | 250 V/130 W | ~60 nm/min |
| ARC | O₂/He (3:1) | 25 mTorr | 160 V/75 W | ~100 nm/min |
| removal | | | | |

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed:

1. An article, comprising:
a substrate comprising a plurality of guiding features arranged periodically in two dimensions on or in a surface of the substrate; and
a material capable of forming a periodic structure on the substrate, the periodic structure comprising at least one periodically occurring domain,
wherein the periodicity of the guiding features is at least X times greater than the periodicity of the domains of the periodic structure, wherein X is greater than 1.0.

2. An article as in claim 1, wherein the guiding features are cylindrical posts.

3. An article as in claim 1, wherein the guiding features are posts having a cross-section with a rotational symmetry equal to a local rotational symmetry of the periodic structure.

4. An article as in claim 1, wherein the guiding features have a cross-section having a shape that is substantially circular, oval, square, rectangular, pentagonal, triangular, or hexagonal.

5. An article as in claim 1, wherein a first portion of an individual guiding feature has a cross-sectional dimension that is less than the cross-sectional dimension of a second portion of the guiding feature.

6. An article as in claim 1, wherein at least a portion of an individual guiding feature comprises a surface coating which enhances the wetting ability of at least one but not of all of the domains of the material exposed to the surface of the guiding feature.

7. An article as in claim 1, wherein the distance between each guiding feature and a nearest, adjacent guiding feature is greater than a dimension of the domain.

8. An article as in claim 1, wherein the substrate comprises a plurality of guiding features arranged periodically on the surface of the substrate and the periodic structure is at least partially oriented by the guiding features.

9. An article as in claim 1, wherein the material is a polymeric material and the periodic structure comprises at least a first and a second domain formed by self-assembly of the polymeric material.

10. An article as in claim 9, wherein the material is a block polymer.

11. An article as in claim 10, wherein the block polymer comprises domains which can be selectively removed or chemically transformed within the periodic structure.

12. An article as in claim 11, wherein the block polymer comprises a polymethylmethacrylate, polyferrocenylsilane or polydimethylsiloxane block.

13. An article as in claim 10, wherein the block polymer is polystyrene-b-polyferrocenylsilane, polystyrene-b-polydimethylsiloxane, polyisoprene-b-polydimethylsiloxane, or polystyrene-b-polymethylmethacrylate.

14. An article as in claim 1, wherein the material comprises metal atoms.

15. An article as in claim 1, wherein the material comprises core-shell nanoparticles, with molecular or macromolecular organic soft shells.

16. An article as in claim 1, wherein the periodic structure is a triangular lattice and the guiding features are arranged periodically in two dimensions on a triangular lattice.

17. An article as in claim 1, wherein the periodic structure is a triangular lattice and the guiding features are arranged periodically in two dimensions on a rectangular lattice that is commensurate with the triangular lattice of the periodic structure.

18. An article as in claim 1, wherein the guiding features comprise topography with an average height comparable to the thickness of the material.

19. An article as in claim 1, wherein the substrate comprises a polymeric material.

20. An article as in claim 1, wherein X is greater than 2.

21. An article as in claim 1, wherein X is greater than 5.

22. An article as in claim 1, wherein X is greater than 10.

23. An article as in claim 1, wherein X is greater than 25.

24. An article as in claim 1, wherein X is greater than 50.

25. An article as in claim 1, wherein X is greater than 75.

26. An article as in claim 1, wherein X is greater than 100.

27. A method of forming a patterned substrate, comprising:
providing a base material;
effecting differential reaction, within the base material, to define a patterned substrate precursor, the precursor comprising a plurality of features solidified relative to material surrounding the features;
removing base material adjacent the patterned substrate precursor; and
treating the substrate precursor to reduce the size of the features, such that the features have at least one dimension that is 100 nm or less, thereby forming a patterned substrate.

28. A method as in claim 27, wherein the patterned substrate comprises a plurality of guiding features arranged periodically in two dimensions on or in a surface of the patterned substrate.

29. A method as in claim 28, further comprising contacting the patterned substrate with a material capable of forming a periodic structure on the patterned substrate, the periodic structure comprising at least a first periodically occurring domain and a second domain.

30. A method as in claim 29, further comprising treating the periodic structure to remove at least one periodically occurring domain, such that at least one other periodically occurring domain is not removed by said treatment.

31. A method as in claim 30, wherein the second domain is a periodically occurring domain.

32. An article as in claim 1, wherein at least a portion of the guiding features are arranged on or in the surface of the substrate as a pattern of features having different surface energy properties relative to other portions of the substrate.

33. An article as in claim 32, wherein the guiding features affect the wetting ability of at least one domain of the material.

34. An article as in claim 1, wherein the article comprises a superlattice comprising a first set of guiding features and a sublattice comprising a second set of guiding features.

35. An article as in claim 34, wherein the first set of guiding features comprises posts and the second set of guiding features does not comprise posts.

36. A method as in claim 27, wherein the act of treating comprises exposure to O₂ plasma.
